(19) United States
(12) Patent Application Publication
(10) Pub. No.: US 2009/0128119 A1
(43) Pub. Date: May 21, 2009

(54) DIFFERENTIAL OUTPUT CIRCUIT

(75) Inventor: Masaharu MORII, Shinjuku-ku (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Tokyo (JP)

(21) Appl. No.: 12/271,463

(22) Filed: Nov. 14, 2008

(30) Foreign Application Priority Data
Nov. 16, 2007 (JP) 2007-297669
Oct. 28, 2008 (JP) 2008-276485

(51) Int. Cl. H02J 3/12

(52) U.S. Cl. 323/349; 323/353

(57) ABSTRACT

A differential output circuit comprising: a first power supply line; a constant current source that includes a current input terminal coupled to the first power supply line; an output common mode voltage setting unit that includes a variable resistor element, one end of the variable resistor element being coupled to a current output terminal of the constant current source; and a signal transmission unit that includes a first power supply terminal and a second power supply terminal, the first power supply terminal being coupled to the other end of the variable resistor element, and the second power supply terminal being coupled to a second power supply line which supplies a voltage lower than a voltage of the first power supply line.

### CROSS-REFERENCE TO RELATED APPLICATIONS

This application claims the benefit of priority from Japanese Patent Application No. 2007-297669 filed on Nov. 16, 2007 and Japanese Patent Application No. 2008-276485 filed on Oct. 28, 2008, the entire contents of which are incorporated herein by reference.

### BACKGROUND OF THE INVENTION

1. Field of the Invention

Aspects of the present application relate to a differential output circuit.

2. Description of Related Art

High-speed process is desirable for data transfer among LSI chips or the like. For this reason, for example, differential output circuits may be used in the data transfer among the LSI chips or the like. Since the transferred signal is converted into a small amplitude differential signal, such as a low voltage differential signaling (LVDS), high-speed data transfer with reduced power supply noise may be possible.

For instance, a differential output circuit is discussed in Japanese Laid-open Patent Publication No. 2005-123773, Japanese Laid-open Patent Publication No. 2004-112453, Japanese Laid-open Patent Publication No. 2006-60416, Japanese Laid-open Patent Publication No. H11-4158, Japanese Laid-open Patent Publication No. 2006-340226, Japanese Laid-open Patent Publication No. 2007-134940, U.S. Pat. No. 6,590,422, U.S. Pat. No. 7,183,804, U.S. Pat. No. 7,336,780, Japanese Laid-open Patent Publication No. H11-150469 or the like.

### SUMMARY

Aspects of an embodiment include a differential output circuit comprising: a first power supply line; a constant current source that includes a current input terminal coupled to the first power supply line; an output common mode voltage setting unit that includes a variable resistor element, one end of the variable resistor element being coupled to a current output terminal of the constant current source; and a signal transmission unit that includes a first power supply terminal and a second power supply terminal, the first power supply terminal being coupled to the other end of the variable resistor element, and the second power supply terminal being coupled to a second power supply line which supplies a voltage lower than a voltage of the first power supply line.

Additional advantages and novel features of aspects in accordance with the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates a differential output circuit;

FIGS. 2A and 2B illustrate exemplary output voltages of external output terminals;

FIG. 3 illustrates another differential output circuit;

FIGS. 4A and 4B illustrate other exemplary output voltages of external output terminals;

FIGS. 5A and 5B illustrate further exemplary output voltages of external output terminals;

FIGS. 6A and 6B illustrate further exemplary output voltages of external output terminals;

FIG. 7 illustrates aspects of a first embodiment;

FIG. 8 illustrates a bias circuit according to aspects of the first embodiment;

FIGS. 9A and 9B illustrate exemplary output voltages of external output terminals according to aspects of the first embodiment;

FIG. 10 illustrates input/output waveforms according to aspects of the first embodiment;

FIG. 11 illustrates aspects of a second embodiment;

FIG. 12 illustrates a bias circuit according to aspects of the second embodiment;

FIG. 13 illustrates another bias circuit according to aspects of the second embodiment;

FIG. 14 illustrates a third embodiment;

FIG. 15 illustrates a bias circuit according to aspects of the third embodiment;

FIGS. 16A and 16B illustrate exemplary output voltages of external output terminals according to the third embodiment;

FIG. 17 illustrates aspects of a fourth embodiment;

FIG. 18 illustrates a bias circuit according to aspects of the fourth embodiment;

FIG. 19 illustrates another bias circuit according to aspects of the fourth embodiment;

FIG. 20 illustrates aspects of a fifth embodiment;

FIGS. 21A and 21B illustrate exemplary output voltages of external output terminals according to aspects of the fifth embodiment;

FIG. 22 illustrates a reflection-measurement model according to aspects of the fifth embodiment;

FIG. 23 illustrates a frequency characteristic of an S-parameter;

FIG. 24 illustrates aspects of a frequency characteristic of another S-parameter;

FIG. 25 illustrates aspects of a sixth embodiment;

FIGS. 26A and 26B illustrate exemplary output voltages of external output terminals according to aspects of the sixth embodiment;

FIG. 27 illustrates aspects of a seventh embodiment;

FIGS. 28A and 28B illustrate exemplary output voltages of external output terminals according to aspects of the seventh embodiment;

FIG. 29 illustrates aspects of an eighth embodiment;

FIGS. 30A and 30B illustrate exemplary output voltages of external output terminals according to aspects of the eighth embodiment; and

FIG. 31 illustrates aspects of a ninth embodiment.

### DESCRIPTION OF PREFERRED EMBODIMENTS

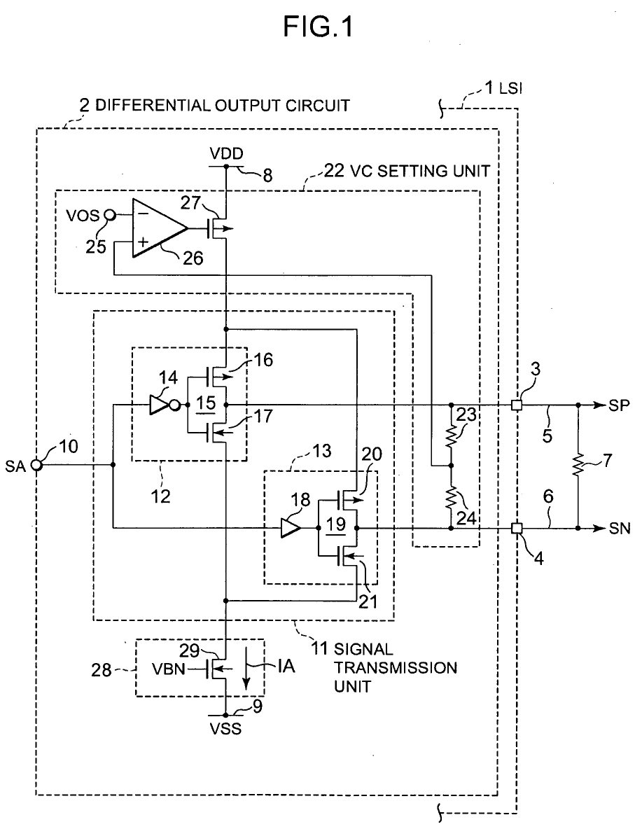

FIG. 1 illustrates a differential output circuit. Reference numeral 1 indicates a sender-side LSI. Reference numeral 2 indicates one example of a differential output circuit. Reference numerals 3 and 4 indicate external output terminals of the LSI 1. Reference numerals 5 and 6 indicate signal lines. Reference numeral 7 indicates a termination resistor, for example, a resistance value of which is 100Ω. Illustration of a recipient-side LSI is omitted.

Reference numeral 8 indicates a VDD power supply line for supplying a positive power supply voltage VDD. Reference numeral 9 indicates a VSS power supply line for supplying a power supply voltage VSS, such as negative voltage or 0V. Reference numeral 10 indicates an internal signal terminal, to which an input signal SA is supplied. Reference numeral 11 indicates a signal transmission unit. Reference numeral 12 indicates an output buffer, to which the input signal SA is input, and from which an in-phase output signal SP is output. Reference numeral 13 indicates an output buffer, to which the input signal SA is input, and from which an anti-phase output signal SN is output.

Reference numerals 14 and 15 indicate inverters. Reference numeral 16 indicates a PMOS transistor. Reference numeral 17 indicates an NMOS transistor. Reference numeral 18 indicates a buffer including two inverters that are coupled in cascade. Reference numeral 19 indicates an inverter. Reference numeral 20 indicates a PMOS transistor, and Reference numeral 21 indicates an NMOS transistor.

Reference numeral 22 indicates a VC setting unit that sets an output common mode voltage VC. Resistors 23 and 24 serve as a VCM detection circuit that detects an average voltage VCM of the output signal SP and the output signal SN. Reference numeral 25 indicates a common mode voltage setting terminal, to which a common mode voltage VOS is supplied. Reference numeral 26 indicates an operational amplifier. Reference numeral 27 indicates a PMOS transistor. Resistance values of the resistors 23 and 24 are large enough in comparison with a resistance value of the termination resistor 7. Reference numeral 28 indicates a constant current source. Reference numeral 29 indicates an NMOS transistor. Reference symbol VBN indicates a gate-bias voltage supplied to a gate of the NMOS transistor 29. A bias circuit (not shown) generates the gate-bias voltage.

An output differential voltage VD, which is a difference in voltages between the output signal SP and the output signal SN, is determined based upon a constant current IA of the constant current source 28 and the resistance value of the termination resistor 7. Since the VC setting unit 22 includes a negative feedback loop, an ON-resistance value of the PMOS transistor 27 is represented, based upon an output voltage of the operational amplifier 26, as follows:

Output common mode voltage VC=Common mode voltage VOS

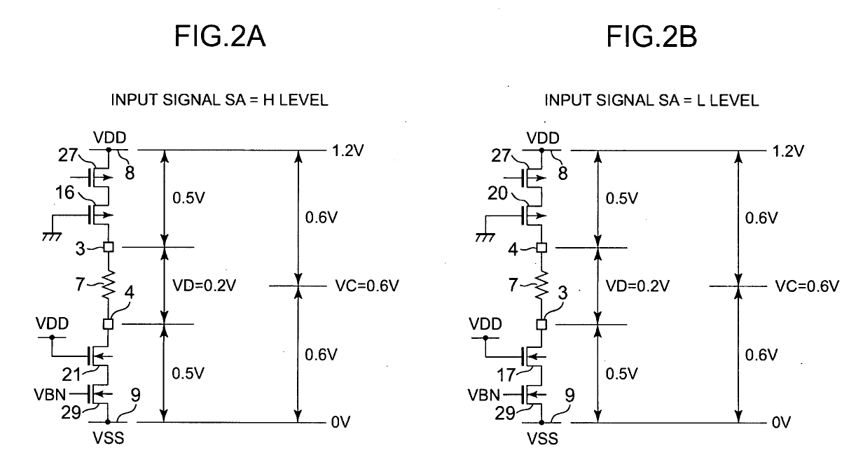

FIGS. 2A and 2B illustrate exemplary output voltages of the external output terminals 3 and 4. FIG. 2A indicates where the input signal SA is a high level. FIG. 2B indicates where the input signal SA is a low level.

For example, where the power supply voltage VDD is equal to 1.2V and the power supply voltage VSS is equal to 0V, a DC specification of the differential output circuit 2 may be defined as follows:

Output differential voltage VD=0.2 Vp-p

Output common mode voltage VC=VDD/2=0.6V

If the input signal SA is the high level, as shown in FIG. 2A, 0.5V is applied across the VDD power supply line 8 and the external output terminal 3 and across the external output terminal 4 and the VSS power supply line 9. If the input signal SA is the low level, as shown in FIG. 2B, 0.5V is applied across the VDD power supply line 8 and the external output terminal 4 and across the external output terminal 3 and the VSS power supply line 9.

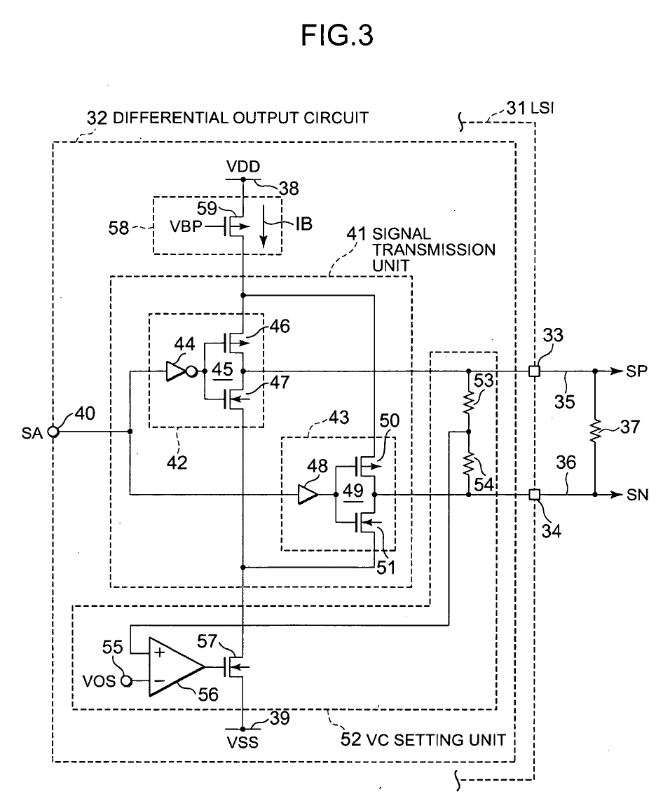

FIG. 3 illustrates another differential output circuit. Reference numeral 31 indicates a sender-side LSI. Reference numeral 32 indicates a differential output circuit. Reference numerals 33 and 34 indicate external output terminals of the LSI 31. Reference numerals 35 and 36 indicate signal lines. Reference numeral 37 indicates a termination resistor, for example, a resistance value of which is 100Ω. Illustration of a recipient-side LSI is omitted.

Reference numeral 38 indicates a VDD power supply line. Reference numeral 39 indicates a VSS power supply line. Reference numeral 40 indicates an internal signal terminal, to which an input signal SA is supplied. Reference numeral 41 indicates a signal transmission unit. Reference numeral 42 indicates an output buffer, to which the input signal SA is input, and from which an in-phase output signal SP is output. Reference numeral 43 indicates an output buffer, to which the input signal SA is input, and from which an anti-phase output signal SN is output.

Reference numerals 44 and 45 indicate inverters. Reference numeral 46 indicates a PMOS transistor. Reference numeral 47 indicates an NMOS transistor. Reference numeral 48 indicates a buffer including two inverters that is coupled in cascade. Reference numeral 49 indicates an inverter. Reference numeral 50 indicates a PMOS transistor and Reference numeral 51 indicates an NMOS transistor.

Reference numeral 52 indicates a VC setting unit for setting an output common mode voltage VC. Resistors 53 and 54 serve as a VCM detection circuit that detects an average voltage VCM of the output signal SP and the output signal SN. Reference numeral 55 indicates a common mode voltage setting terminal, to which a common mode voltage VOS is supplied. Reference numeral 56 indicates an operational amplifier. Reference numeral 57 indicates an NMOS transistor. Resistance values of resistors 56 and 57 are large enough in comparison with a resistance value of the termination resistor 37. Reference numeral 58 indicates a constant current source. Reference numeral 59 indicates a PMOS transistor. Reference symbol VBP indicates a gate-bias voltage supplied to the PMOS transistor 59. A bias circuit (not shown) generates the gate-bias voltage.

An output differential voltage VD is determined based upon a constant current IB of the constant current source 58 and the resistance value of the termination resistor 37. Since the VC setting unit 52 includes a negative feedback loop, an ON-resistance of the NMOS transistor 57 is represented, based on the operational amplifier 56, as follows:

Output common mode voltage VC=common mode voltage VOS

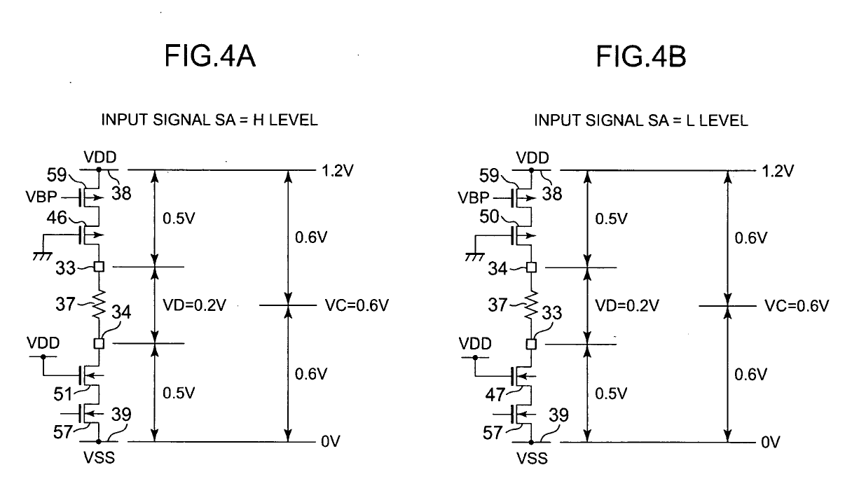

FIGS. 4A and 4B illustrate exemplary output voltages of external output terminals 33 and 34. FIG. 4A indicates where the input signal SA is a high level FIG. 4B indicates where the input signal SA is a low level.

For example, where a power supply voltage VDD is equal to 1.2V and a power supply voltage VSS is equal to 0V, a DC specification of the differential output circuit 32 may be defined as follows:

Output differential voltage VD=0.2 Vp-p

Output common mode voltage VC=VDD/2=0.6V

If the input signal SA is the high level, as shown in FIG. 4A, 0.5V is applied across the VDD power supply line 38 and the external output terminal 33 and across the external output terminal 34 and the VSS power supply line 39. If the input signal SA is the low level, as shown in FIG. 4B, 0.5V is applied across the VDD power supply line 38 and the external output terminal 34 and across the external output terminal 33 and the VSS power supply line 39.

Along with the diversification of high-speed data transmissions, LSI chips having different power supplies are coupled or signal voltage ranges are used to detect operation modes, to check operations or the like. In the above cases, a DC of the output common mode voltage VC is not concentrated in a vicinity of VDD/2 but is concentrated on a side of the VSS or on a side of the VDD.

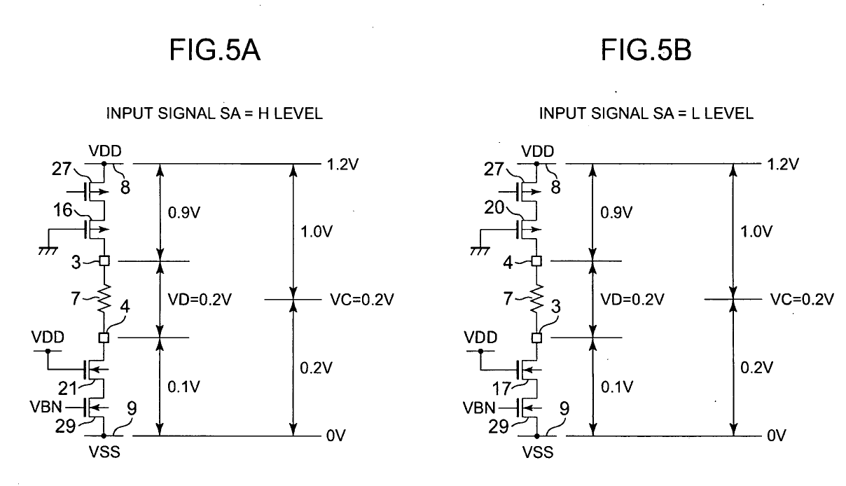

FIGS. 5A and 5B illustrate exemplary output voltages of the external output terminals 3 and 3. FIG. 5A indicates where the input signal SA is the high level. FIG. 5B indicates where the input signal SA is the low level.

For example, where the VDD is equal to 1.2V and the VSS is equal to 0V, the DC specification of the differential output circuit 2 may be defined as follows:

Output differential voltage VD=0.2 Vp-p

Output common mode voltage VC=0.2V

If the input signal SA is the high level, as shown in FIG. 5A, 0.9V is applied across the VDD power supply line 8 and the external output terminal 3 and 0.1V is applied across the external output terminal 4 and the VSS power supply line 9. If the input signal SA is the low level, as shown in FIG. 5B, 0.9V is applied across the VDD power supply line 8 and the external output terminal 4 and 0.1V is applied across the external output terminal 3 and the VSS power supply line 9.

If the input signal SA is the high level, as shown in FIG. 5A, the sum of a drain-source voltage of NMOS transistors 21 and 29 that are coupled in series is 0.1V. If the input signal SA is the low level, as shown in FIG. 5B, the sum of a drain-source voltage of NMOS transistors 17 and 29 that are coupled in series is 0.1V.

In the differential output circuit 2, when a drain-source voltage VDS of the NMOS transistor 29 becomes lower than 0.1V, the NMOS transistor 29 operates in a non-saturated region. Consequently, the constant current IA fluctuates depending on fluctuations in process/temperature/voltage conditions, PTV condition, of the NMOS transistor 29.

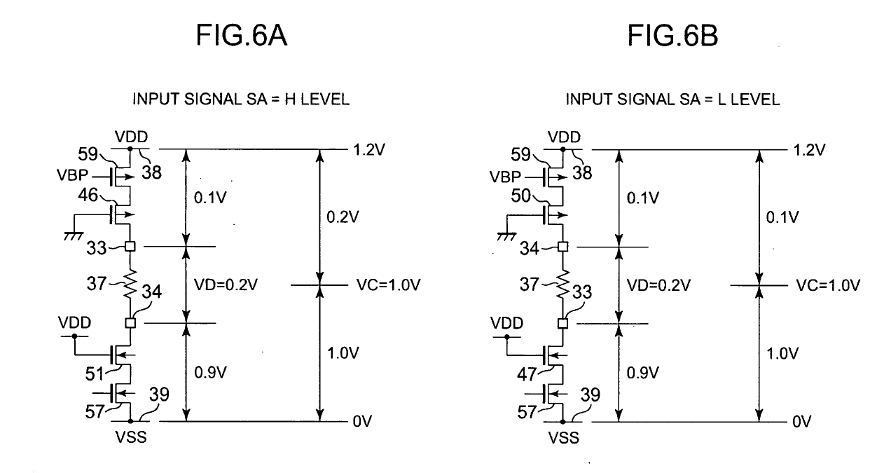

FIGS. 6A and 6B illustrate other exemplary output voltages of the external output terminals 33 and 34. In FIGS. 6A and 6B, a DC specification of the common mode voltage VC is concentrated on the side of the VDD. FIG. 6A indicates where the input signal SA is the high level. FIG. 6B indicates where the input signal SA is the low level.

For example, where the VDD is equal to 1.2V and the VSS is equal to 0V, a DC specification of the differential output circuit 32 may be defined as follows:

Output differential voltage VD=0.2 Vp-p

Output common mode voltage VC=1.0V

If the input signal SA is the high level, as shown in FIG. 6A, 0.1V is applied across the VDD power supply line 38 and the external output terminal 33 and 0.9V is applied across the external output terminal 34 and the VSS power supply line 39. If the input signal SA is the low level, as shown in FIG. 6B, 0.1V is applied across the VDD power supply line 38 and the external output terminal 34 and 0.9V is applied across the external output terminal 33 and the VSS power supply line 39.

In the differential output circuit 32, when a source-drain voltage VSD of the PMOS transistor 59 becomes lower than 0.1V, the PMOS transistor 59 operates in a non-saturated region. Consequently, the constant current IB fluctuates depending on fluctuations in process/temperature/voltage conditions, PTV condition, of the PMOS transistor 59.

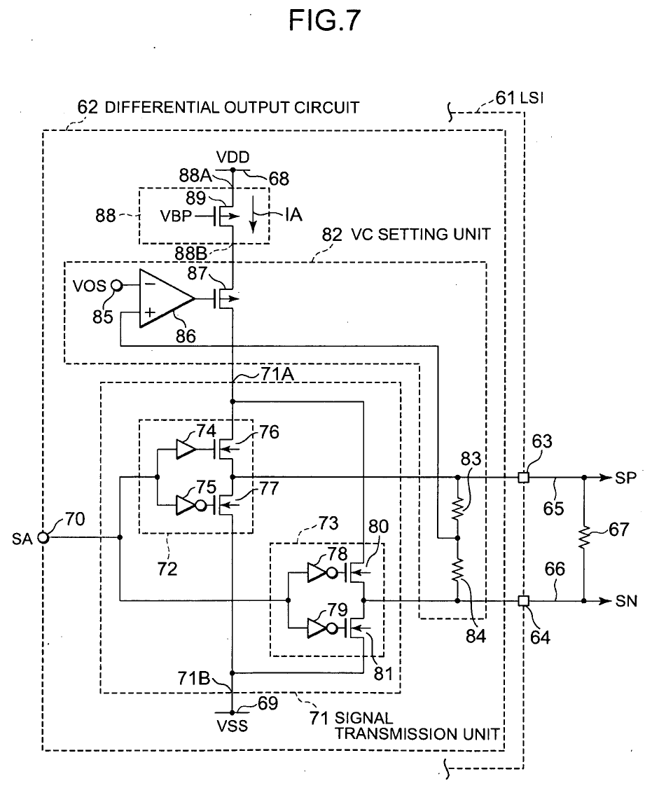

FIG. 7 illustrates aspects of a first embodiment. Reference numeral 61 indicates a sender-side LSI. Reference numeral 62 indicates a differential output circuit. Reference numerals 63 and 64 indicate external output terminals of the LSI 61. Reference numeral 65 indicates a signal line coupled to the external output terminal 63. Reference numeral 66 indicates a signal line coupled to the external output terminal 64. Reference numeral 67 indicates a termination resistance, for example, a resistance value of which is 100Ω, coupled between the signal line 65 and the signal line 66. Illustration of a recipient-side LSI is omitted.

The differential output circuit 62 is suitable where a DC specification of an output common mode voltage VC is concentrated on a side of a VSS away from VDD/2. Reference numeral 68 indicates a VDD power supply line. Reference numeral 69 indicates a VSS power supply line. Reference numeral 70 indicates an internal signal terminal, to which an input signal SA from an internal circuit (not shown) is supplied.

Reference numeral 71 indicates a signal transmission unit. Reference numeral 72 indicates an output buffer, to which the input signal SA is supplied, and from which an in-phase output signal SP is output. Reference numeral 73 indicates is an output buffer, to which the input signal SA is input, and from which an anti-phase output signal SN is output.

Reference numeral 74 indicates a buffer including two inverters that are coupled in cascade. Reference numeral 75 is an inverter. Reference numerals 76 and 77 indicate an output circuit that includes a totem-pole circuit having NMOS transistors. Reference numeral 78 indicates an inverter. Reference numeral 79 indicates a buffer, to which two inverters are coupled in cascade. Reference numerals 80 and 81 indicate an output circuit that includes a totem-pole circuit having NMOS transistors.

An input terminal of the buffer 74 is coupled to the internal signal terminal 70 and an output terminal of the buffer 74 is coupled to a gate of the MNMOS transistor 76. An input terminal of the inverter 75 is coupled to the internal signal terminal 70 and an output terminal of the inverter 75 is coupled to a gate of the NMOS transistor 77.

A drain of the NMOS transistor 76 is coupled to a first power supply terminal 71A of the signal transmission unit 71 and a source of the NMOS transistor 76 is coupled to a drain of the NMOS transistor 77. A source of the NMOS transistor 77 is coupled to a second power supply terminal 71B of the signal transmission unit 71. A coupling node between the source of the NMOS transistor 76 and the drain of the NMOS transistor 77 is coupled to the external output terminal 63.

An input terminal of the inverter 78 is coupled to the internal signal terminal 70 and an output terminal of the inverter 78 is coupled to a gate of the NMOS transistor 80. An input terminal of the buffer 79 is coupled to the internal signal terminal 70 and an output terminal of the buffer 79 is coupled to a gate of the NMOS transistor 81.

A drain of the NMOS transistor 80 is coupled to the first power supply terminal 71A of the signal transmission unit 71 and a source of the NMOS transistor 80 is coupled to a drain of the NMOS transistor 81. A source of the NMOS transistor 81 is coupled to the second power supply terminal 71B of the signal transmission unit 71. A coupling node between the source of the NMOS transistor 80 and the drain of the NMOS transistor 81 is coupled to the external output terminal 64.

The second power supply terminal 71B of the signal transmission unit 71 is coupled to the VSS power supply line 69.

The output circuit in the output buffer 72 is the totem-pole circuit that includes the NMOS transistors 76 and 77. The output circuit in the output buffer 73 is the totem-pole circuit that includes the NMOS transistors 80 and 81. Therefore, influence of a substrate bias effect is reduced.

Reference numeral 82 indicates a VC setting unit for setting the output common mode voltage VC. Resistors 83 and 84 serve as a VCM detection circuit that detects an average voltage VCM of the output signal SP and the output signal SN.

Reference numeral 85 indicates a common mode voltage setting terminal, to which a common mode voltage VOS is supplied. Reference numeral 86 indicates an operational amplifier. Reference numeral 87 indicates a PMOS transistor as a variable resistor element. The PMOS transistor 87 controls a power supply voltage supplied to the first power supply terminal 71A of the signal transmission unit 71. Resistance values of the resistors 83 and 84 are large enough in comparison with a resistance value of the termination resistor 67.

The resistors 83 and 84 are coupled in series between the external output terminal 63 and the external output terminal 64. A coupling node between the resistor 83 and the resistor 84 is coupled to a non-inverting input terminal of the operational amplifier 86. The common mode voltage-setting terminal 85 is coupled to an inverting input terminal of the operational amplifier 86. An output terminal of the operational amplifier 86 is coupled to a gate of the PMOS transistor 87. A drain of the PMOS transistor 87 is coupled to the first power supply terminal 71A of the signal transmission unit 71.

Reference numeral 88 indicates a constant current source. Reference symbol VBP indicates a gate-bias voltage of a PMOS transistor 89. A source of the PMOS transistor 89 is coupled, via a current input terminal 88A of the constant current source 88, to the VDD power supply line 68. A drain of the PMOS transistor 89 is coupled, via a current output terminal 88B of the constant current source 88, to a source of the PMOS transistor 87.

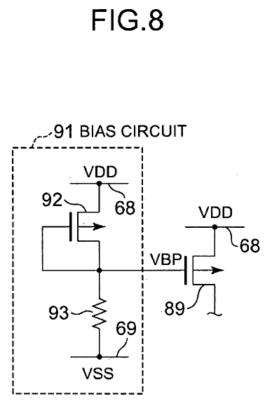

FIG. 8 illustrates a bias circuit. A bias circuit 91 generates the gate-bias voltage VBP. Reference numeral 92 indicates a PMOS transistor. Reference numeral 93 indicates a resistor. A source of the PMOS transistor 92 is coupled to the VDD power supply line 68 and a gate of the PMOS transistor 92 is coupled to a drain thereof. The drain of the PMOS transistor 92 is couple to the VSS power supply line 69 via the resistor 93. The gate-bias voltage VBP is supplied to the drain of the PMOS transistor 92. The drain of the PMOS transistor 92 is coupled to a gate of the PMOS transistor 89. The PMOS transistor 92 and the PMOS transistor 89 include a current mirror circuit.

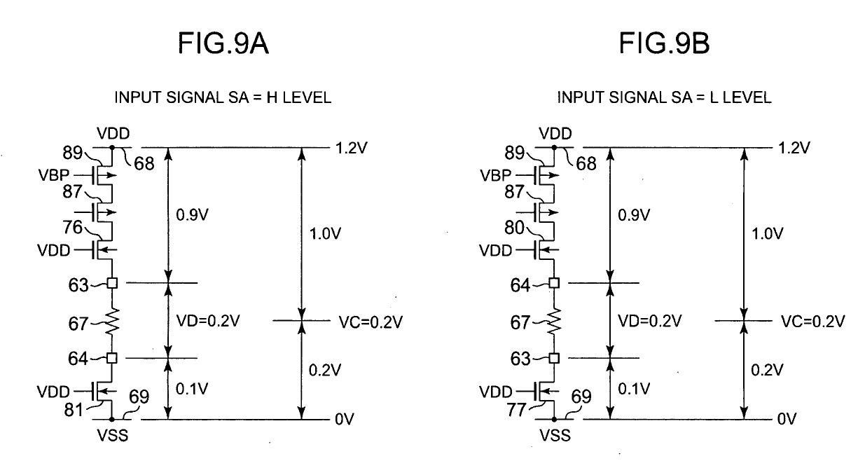

FIGS. 9A and 9B illustrate exemplary output voltages of external output terminals 63 and 64. FIG. 9A illustrates examples when the input signal SA is a high level. FIG. 9B illustrates examples when the input signal SA is a low level.

For example, when a power supply voltage VDD is equal to 1.2V and a power supply voltage VSS is equal to 0V, a DC specification of the differential output circuit 62 may be defined as follows:

Output differential voltage VD=0.2 Vp-p

Output common mode voltage VC=0.2V

If the input signal SA is the high level, as shown in FIG. 9A, 0.9V is applied across the VDD power supply line 68 and the external output terminal 63 and 0.1V is applied across the external output terminal 64 and the VSS power supply line 69. If the input signal SA is the low level, as shown in FIG. 9B, 0.9V is applied across the VDD power supply line 68 and the external output terminal 64 and 0.1V is applied across the external output terminal 63 and the VSS power supply line 69. Regardless of whether the input signal SA is the high level or the low level, enough voltage is provided as a source-drain voltage VSD of the PMOS transistor 89 that serves as the constant current source 88.

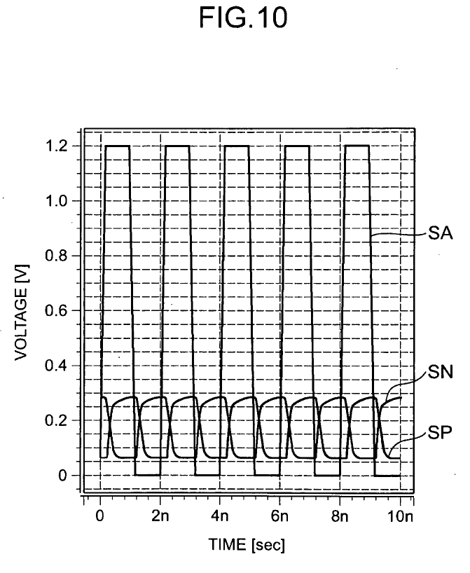

FIG. 10 illustrates input/output waveforms of the first embodiment. FIG. 10 indicates circuit simulation waveforms in the following condition, that is, as shown in FIGS. 9A and 9B, the VDD is equal to 1.2V and the VSS is equal to 0V and the DC specification of the differential output circuit 62 may be defined in the following formulae, that is, the output differential voltage VD=0.2 Vp-p and the output common mode voltage VC=0.2V. The waveforms in FIG. 10 indicate that a DC specification of the output common mode voltage VC is satisfied.

For example, where the VDD is equal to 1.2V and the VSS is equal to 0V, the DC specification of the differential output circuit 62 may be defined as follows:

Output differential voltage VD=0.2 Vp-p

Output common mode voltage VC=VDD/2=0.6V

If the input signal SA is the high level, 0.5V is applied across the VDD power supply line 68 and the external output terminal 63 and across the external output terminal 64 and the VSS power supply line 69. If the input signal SA is the low level, 0.5V is applied across the VDD power supply line 68 and the external output terminal 64 and across the external output terminal 63 and the VSS power supply line 69. Enough voltage is provided as the source-drain voltage VSD of the PMOS transistor 89 that includes the constant current source 88.

According to aspects of the first embodiment, if the VC setting unit 82 is provided on an upstream side of the signal transmission unit 71 on a current path to the VSS power supply line 69 from the VDD power supply line 68, the constant current source 88 is coupled between the VDD power supply line 68 and the source of the PMOS transistor 87 of the VC setting unit 82. Therefore, even if the DC specification of the output common mode voltage VC is concentrated on the side of the VSS away from a vicinity of VDD/2, enough voltage is provided as the source-drain voltage VSD of the PMOS transistor 89 that serves as the constant current source 88.

According to aspects of the first embodiment, even if the DC specification of the output common mode voltage VC is concentrated on the side of the VSS away from the vicinity of VDD/2, the DC specification of the output common mode voltage VC is satisfied. Consequently, an improvement in yield may be achieved.

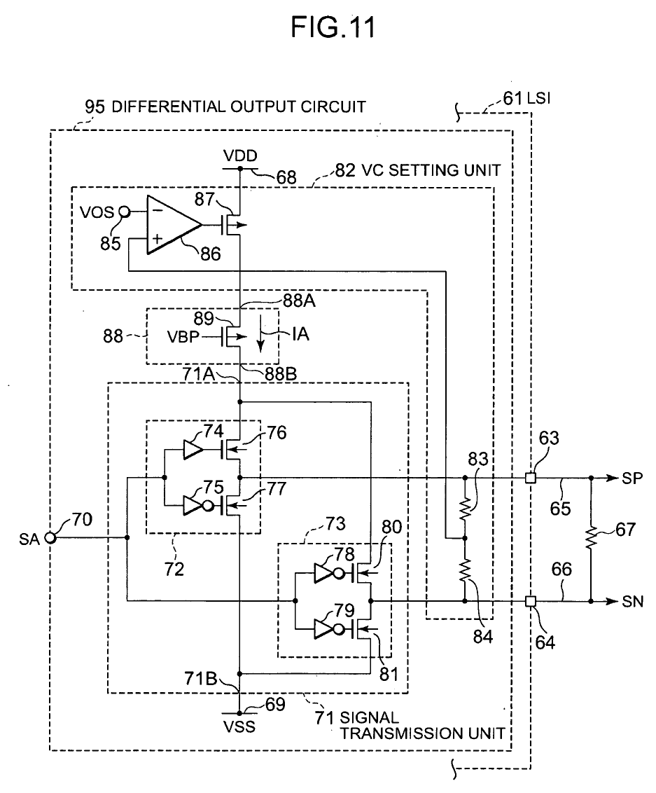

FIG. 11 illustrates aspects of a second embodiment. A source of a PMOS transistor 87 of a VC setting unit 82 is coupled to a VDD power supply line 68. A constant current source 88 is coupled between a drain of the PMOS transistor 87 of the VC setting unit 82 and a first power supply terminal 71A of a signal transmission unit 71. Other structural elements may be the same as those of the first embodiment.

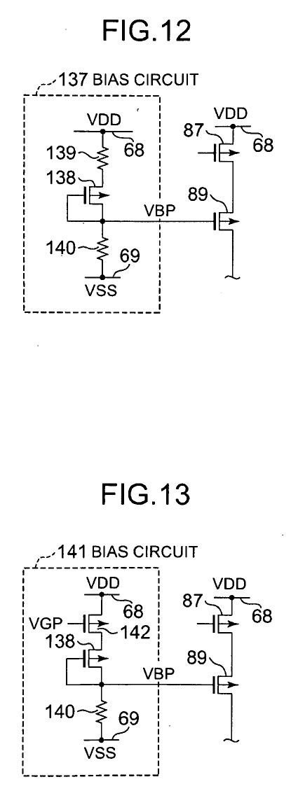

FIG. 12 illustrates a bias circuit for a PMOS transistor 89 in the second embodiment. Reference numeral 137 indicates a bias circuit. Reference numeral 138 indicates a PMOS transistor. Reference numerals 139 and 140 indicate resistors. A source of the PMOS transistor 138 is coupled, via the resistor 139, to the VDD power supply line 68. A gate of the PMOS transistor 138 is coupled to a drain thereof. The drain of the PMOS transistor 138 is coupled, via the resistor 140, to a VSS power supply line 69. A gate-bias voltage VBP is supplied to the drain of the PMOS transistor 138. The PMOS transistor 138 is coupled to a gate of the PMOS transistor 89. The PMOS transistor 138 and the PMOS transistor 89 include a current mirror circuit.

As a replicated element of the PMOS transistor 87, the bias circuit 137 includes the resistor 139 that is a linear element. The resistor 139 is provided between the VDD power supply line 68 and the source of the PMOS transistor 138.

A channel conductance |gm| is adjusted by increasing a gate-source voltage |VGS| of the PMOS transistor 89, so that fluctuations in an output differential voltage VD may be suppressed.

FIG. 13 illustrates a bias circuit for another PMOS transistor 89 in the second embodiment. A bias circuit 141 includes a PMOS transistor 142 instead of the resistor 139 of the bias circuit 137 shown in FIG. 12. Other structural elements are the same as those of the bias circuit 137. In the bias circuit 141, since a gate voltage VGP is set within a range where an operating range of the PMOS transistor 142 falls within a linear range, the same advantages as those of the bias circuit 137 may be obtained.

For example, when a power supply voltage VDD is equal to 1.2V and a power supply voltage VSS is equal to 0V, a DC specification of a differential output circuit 95 may be defined as follows:

Output differential voltage VD=0.2 Vp-p

Output common mode voltage VC=0.2V

If an input signal SA is an high level, 0.9V is applied across the VDD power supply line 68 and an external output terminal 63 and 0.1V is applied across an external output terminal 64 and the VSS power supply line 69. If the input signal SA is a low level, 0.9V is applied across the VDD power supply line 68 and the external output terminal 64 and 0.1V is applied across the external output terminal 63 and the VSS power supply line 69. Regardless of whether the input signal SA is the high level or the low level, enough voltage is provided as a source-drain voltage VSD of the PMOS transistor 89 that serves as the constant current source 88.

For example, when the VDD is equal to 1.2V and the VSS is equal to 0V, the DC specification of the differential output circuit 95 may be defined as follows:

Output differential voltage VD=0.2 Vp-p

Output common mode voltage VC=VDD/2=0.6V

If the input signal SA is the high level, 0.5V is applied across the VDD power supply line 68 and the external output terminal 63 and across the external output terminal 64 and the VSS power supply line 69. If the input signal SA is the low level, 0.5V is applied across the VDD power supply line 68 and the external output terminal 64 and across the external output terminal 63 and the VSS power supply line 69. Enough voltage is provided as the source-drain voltage VSD of the PMOS transistor 89 that serves as the constant current source 88.

According to aspects of the second embodiment, if the VC setting unit 82 is provided on an upstream side of the signal transmission unit 71 on a current path to the VSS power supply line 69 from the VDD power supply line 68, the constant current source 88 is coupled between the drain of the PMOS transistor 87 of the VC setting unit 82 and the first power supply terminal 71A of the signal transmission unit 71. Therefore, even if a DC specification of the output common mode voltage VC is concentrated on a side of the VSS away from a vicinity of VDD/2, enough voltage is provided as the source-drain voltage VSD of the PMOS transistor 89 that serves as the constant current source 88. Even if the DC specification of the output common mode voltage VC is concentrated on the side of the VSS away from the vicinity of VDD/2, the DC specification of the output common mode voltage VC is satisfied, so that an improvement in yield may be achieved.

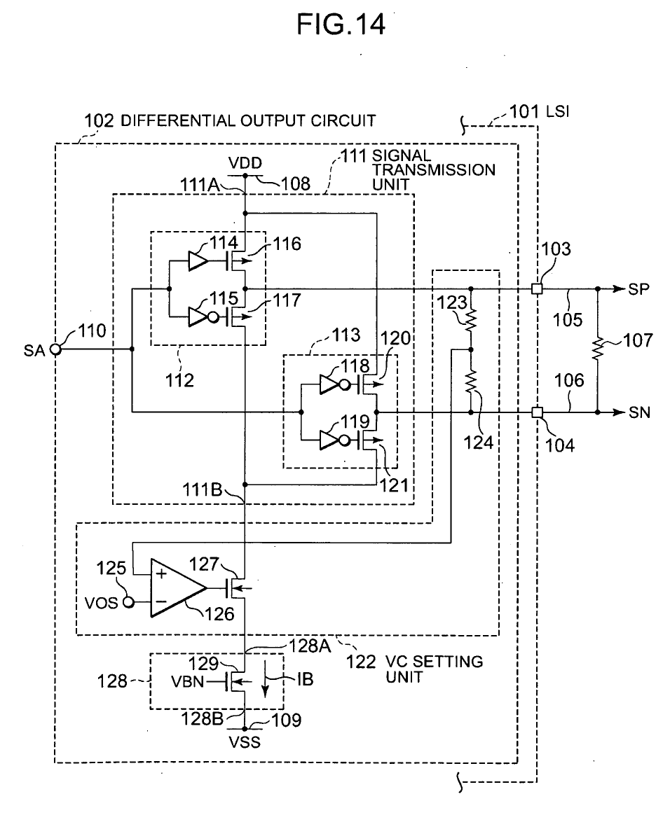

FIG. 14 illustrates aspects of a third embodiment. Reference numeral 101 indicates a sender-side LSI. Reference numerals 103 and 104 indicate external output terminals of the LSI 101. Reference numeral 105 indicates a signal line coupled to the external output terminal 103. Reference numeral 106 indicates a signal line coupled to the external output terminal 104. Reference numeral 107 indicates a termination resistor, for example, a resistance value of which is 100Ω, coupled between the signal line 105 and the signal line 106. Illustration of a recipient-side LSI is omitted.

A differential output circuit 102 is suitable where a DC specification of an output common mode voltage VC is concentrated on a side of a VDD away from VDD/2.

Reference numeral 108 indicates a VDD power supply line. Reference numeral 109 indicates a VSS power supply line. Reference numeral 110 indicates an internal signal terminal, to which an input signal SA from an internal circuit (not shown) is supplied.

Reference numeral 111 indicates a signal transmission unit. Reference numeral 112 indicates an output buffer, to which the input signal SA is input, and from which an in-phase output signal SP is output. Reference numeral 113 indicates an output buffer, to which the input signal SA is input, and from which an anti-phase output signal SN is output.

Reference numeral 114 indicates an inverter. Reference numeral 115 indicates a buffer including two inverters that are coupled in cascade. Reference numerals 116 and 117 indicate an output circuit that includes a totem-pole circuit having PMOS transistors. Reference numeral 118 indicates a buffer including two inverters that are coupled in cascade. Reference numeral 119 indicates an inverter. Reference numerals 120 and 121 indicate an output circuit that includes a totem-pole circuit having PMOS transistors.

An input terminal of the inverter 114 is coupled to the internal input terminal 110 and an output terminal of the inverter 114 is coupled to a gate of the PMOS transistor 116. An input terminal of the buffer 115 is coupled to the internal signal terminal 110 and an output terminal of the buffer 115 is coupled to a gate of the PMOS transistor 117.

A source of the PMOS transistor 116 is coupled to a first power supply terminal 111A of the signal transmission unit 111, and a drain of the PMOS transistor 116 is coupled to a source of the PMOS transistor 117. A drain of the PMOS transistor 117 is coupled to a second power supply terminal 111B of the signal transmission unit 111. A coupling node between the drain of the PMOS transistor 116 and the source of the PMOS transistor 117 is coupled to the external output terminal 103.

An input terminal of the buffer 118 is coupled to the internal signal terminal 110, and an output terminal of the buffer 118 is coupled to a gate of the PMOS transistor 120. An input terminal of the inverter 119 is coupled to the internal signal terminal 110, and an output terminal of the inverter 119 is coupled to a gate of the PMOS transistor 121.

A source of the PMOS transistor 120 is coupled to the first power supply terminal 111A of the signal transmission unit 111, and a drain of the PMOS transistor 120 is coupled to a source of the PMOS transistor 121. A drain of the PMOS transistor 121 is coupled to the second power supply terminal 111B of the signal transmission unit 111. A connection node between the drain of the PMOS transistor 120 and the source of the PMOS transistor 121 is coupled to the external output terminal 104. The first power supply terminal 111A of the signal transmission unit 111 is coupled to the VDD power supply line 108.

In the differential output circuit 102, the output circuit in the output buffer 112 includes the totem-pole circuit that includes the PMOS transistors 116 and 117. The output circuit in the output buffer 113 includes the totem-pole circuit that includes the PMOS transistors 120 and 121. Consequently, influence of a substrate bias effect is reduced.

Reference numeral 122 indicates a VC setting unit for setting an output common mode voltage VC. Resistors 123 and 124 serve as a VCM detection circuit that detects an average voltage VCM of the output signal SP and the output signal SN. Reference numeral 125 indicates a common mode voltage setting terminal, to which a common mode voltage VOS is supplied. Reference numeral 126 indicates an operational amplifier. Reference numeral 127 indicates an NMOS transistor that serves as a variable resistor element. The NMOS transistor 127 controls a power supply voltage supplied to the second power supply terminal 111B of the signal transmission unit 111. Resistance values of the resistors 123 and 124 are large enough in comparison with a resistance value of the termination resistor 107.

The resistors 123 and 124 are coupled in series between the external output terminal 103 and the external output terminal 104. A connection node of the resistors 123 and 124 is coupled to a non-inverting input terminal of the operational amplifier 126. The common mode voltage-setting terminal 125 is coupled to an inverting input terminal of the operational amplifier 126. An output terminal of the operational amplifier 126 is coupled to a gate of the NMOS transistor 127. A drain of the NMOS transistor 127 is coupled to the second power supply terminal 111B of the signal transmission unit 111.

Reference numeral 128 indicates a constant current source. Reference numeral 129 indicates an NMOS transistor. Reference symbol VBN indicates a gate-bias voltage of the NMOS transistor 129. A drain of the NMOS transistor 129 is coupled, via a current input terminal 128A of the constant current source 128, to a source of the NMOS transistor 127. A source of the NMOS transistor 129 is coupled, via a current output terminal 128B of the constant current source 128, to the VSS power supply line 109.

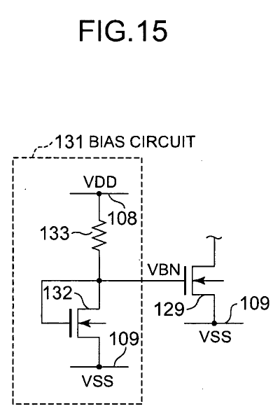

FIG. 15 illustrates a bias circuit that generates the gate-bias voltage VBN. Reference numeral 132 indicates an NMOS transistor. Reference numeral 133 indicates a resistor. A source of the NMOS transistor 132 is coupled to the VSS power supply line 109, and a gate of the NMOS transistor 132 is coupled to a drain thereof. The drain of the NMOS transistor 132 is coupled, via the resistor 133, to the VDD power supply line 108. The gate-bias voltage VBN is supplied to the drain of the NMOS transistor 132. The drain of the NMOS transistor 132 is coupled to a gate of the NMOS transistor 129. The NMOS transistor 132 and the NMOS transistor 129 include a current mirror circuit.

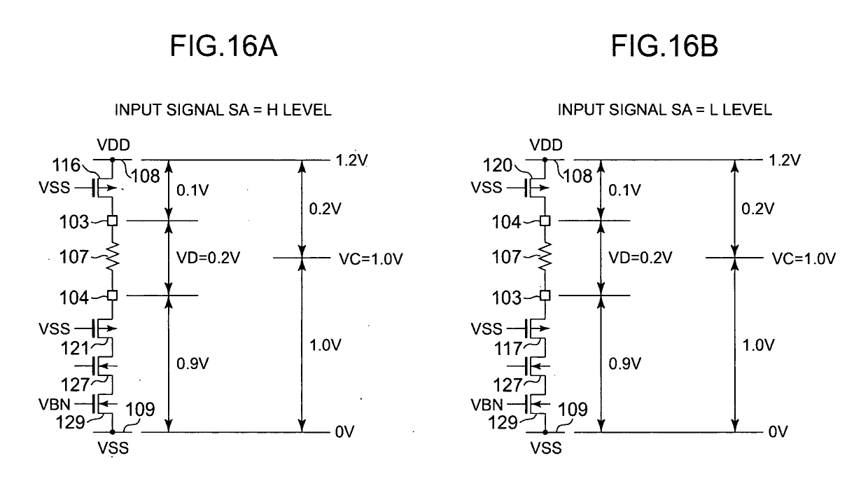

FIGS. 16A and 16B illustrate exemplary output voltages of the external output terminals 103 and 104. FIG. 16A indicates where the input signal SA is an high level, and FIG. 16B indicates where the input signal SA is an low level.

For example, when the power supply voltage VDD is equal to 1.2V and a power supply voltage VSS is equal to 0V, a DC specification of the differential output circuit 102 may be defined as follows:

Output differential voltage VD=0.2 Vp-p

Output common mode voltage VC=1.0V

If the input signal SA is the high level, as shown in FIG. 16A, 0.1V is applied across the VDD power supply line 108 and the external output terminal 103 and 0.9V is applied across the external output terminal 104 and the VSS power supply line 109. If the input signal SA is the low level, as shown in FIG. 16B, 0.1V is applied across the VDD power supply line 108 and the external output terminal 104 and 0.9V is applied across the external output terminal 103 and the VSS power supply line 109. Regardless of whether the input signal SA is the high level or the low level, enough voltage is provided as a drain-source voltage VDS of the NMOS transistor 129 that serves as the constant current source 128.

For example, when the VDD is equal to 1.2V and the VSS is equal to 0V, the DC specification of the differential output circuit 102 may be defined as follows:

Output differential voltage VD=0.2 Vp-p

Output common mode voltage VC=0.6V

If the input signal SA is the high level, 0.5V is applied across the VDD power supply line 108 and the external output terminal 103 and across the external output terminal 104 and the VSS power supply line 109. If the input signal SA is the low level, 0.5V is applied across the VDD power supply line 108 and the external output terminal 104 and across the external output terminal 103 and the VSS power supply line 109. Enough voltage is provided as the drain-source voltage VDS of the NMOS transistor 129 that serves as the constant current source 128.

According to aspects of the third embodiment, if the VC setting unit 122 is provided on a down-stream side of the signal transmission unit 111 on a current path to the VSS power supply line 109 from the VDD power supply line 108, the constant current source 128 is coupled between the source of the NMOS transistor 127 of the VC setting unit 122 and the VSS power supply line 109. Therefore, even if the DC specification of the output common mode voltage VC is concentrated on the side of the VDD away from a vicinity of VDD/2, enough voltage is provided as the drain-source voltage VDS of the NMOS transistor 129 that serves as the constant current source 128. Even if the DC specification of the output common mode voltage VC is concentrated on the side of the VDD away from the vicinity of VDD/2, the DC specification of the output common mode voltage VC is satisfied, so that an improvement in yield may be achieved.

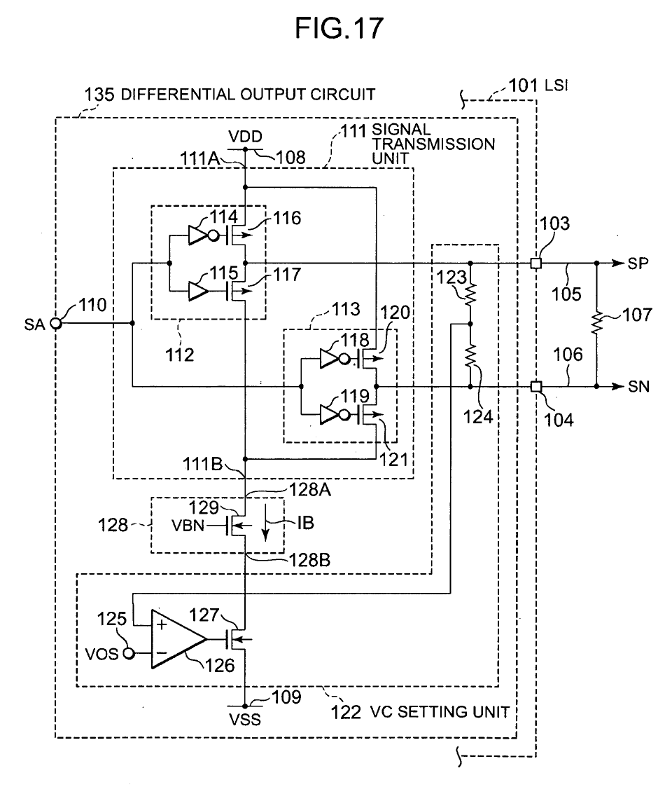

FIG. 17 illustrates aspects of a fourth embodiment. A source of an NMOS transistor 127 of a VC setting unit 122 is coupled to a VSS power supply line 109. A constant current source 128 is coupled between a second power supply terminal 111B of a signal transmission unit 111 and a drain of the NMOS transistor 127 of the VC setting unit 122. Other structural elements are the same as those of the third embodiment.

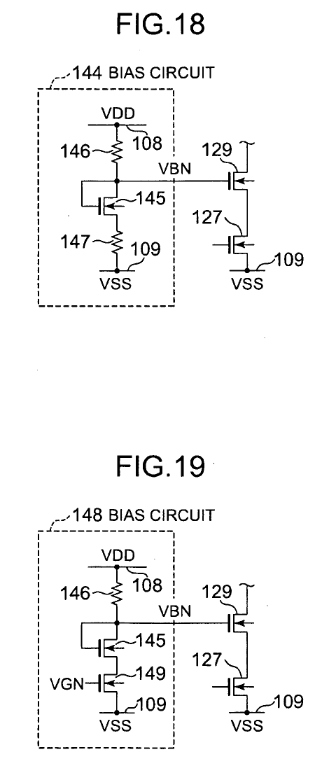

FIG. 18 illustrates aspects of a bias circuit for an NMOS transistor 129 in the fourth embodiment. Reference numeral 145 indicates an NMOS transistor and reference numerals 146 and 147 indicate resistors. A drain of the NMOS transistor 145 is coupled, via the resistor 146, to a VDD power supply line 108, and a gate of the NMOS transistor 145 is coupled to the drain thereof. A source of the NMOS transistor 145 is coupled, via the resistor 147, to a VSS power supply line 109. A gate-bias voltage VBN is supplied to the drain of the NMOS transistor 145. The drain of the NMOS transistor 145 is coupled to a gate of the NMOS transistor 129. The NMOS transistor 145 and the NMOS transistor 129 include a current mirror circuit.

As a replicated element of the NMOS transistor 127, a bias circuit 144 includes the resistor 147 that is a linear element. The resistor 147 is provided between the source of the NMOS transistor 145 and the VSS power supply line 109.

A channel conductance |gm| is adjusted by increasing a gate-source voltage |VGS| of the NMOS transistor 129, so that fluctuations in an output differential voltage VD may be suppressed.

FIG. 19 illustrates aspects of another bias circuit for the NMOS transistor 129 in the fourth embodiment. A bias circuit 148 includes an NMOS transistor 149 instead of the resistor 147 of the bias circuit 144 in FIG. 18. Other structural elements may be the same as those of the bias circuit 144. Since a gate voltage VGN is set within a range where an operating range of the NMOS transistor 149 falls within a linear range, the bias circuit 148 has the same advantages as those of the bias circuit 144.

For example, when a power supply voltage VDD is equal to 1.2V and a power supply voltage VSS is equal to 0V, a DC specification of a differential output circuit 135 may be defined as follows:

Output differential voltage VD=0.2 Vp-p

Output common mode voltage VC=1.0V

If an input signal SA is a high level, 0.1V is applied across the VDD power supply line 108 and an external output terminal 103 and 0.9V is applied across an external output terminal 104 and the VSS power supply line 109. If the input signal SA is a low level, 0.1V is applied across the VDD power supply line 108 and the external output terminal 104 and 0.9V is applied across the external output terminal 103 and the VSS power supply line 109. Regardless of whether the input signal SA is the high level or the low level, enough voltage is provided as a drain-source voltage VDS of the NMOS transistor 129 that serves as the constant current source 128.

For example, when the VDD is equal to 1.2V and the VSS is equal to 0V, the DC specification of the differential output circuit 135 may be defined as follows:

Output differential voltage VD=0.2 Vp-p

Output common mode voltage VC=0.6V

If the input signal SA is the high level, 0.5V is applied across the VDD power supply line 108 and the external output terminal 103 and across the external output terminal 104 and the VSS power supply line 109. If the input signal SA is the low level, 0.5V is applied across the VDD power supply line 108 and the external output terminal 104 and across the external output terminal 103 and the VSS power supply line 109. Enough voltage is provided as the drain-source voltage VDS of the NMOS transistor 129 that serves as the constant current source 128.

According to aspects of the fourth embodiment, if the VC setting unit 122 is provided on a down-stream side of a signal transmission unit 111 on a current path to the VSS power supply line 109 from the VDD power supply line 108, the constant current source 128 is coupled between the second power supply terminal 111B of the signal transmission unit 111 and the drain of the NMOS transistor 127 of the VC setting unit 122. Therefore, even if a DC specification of the output common mode voltage VC is concentrated on a side of the VDD away from a vicinity of VDD/2, the enough voltage is provided as the drain-source voltage VDS of the NMOS transistor 129 that serves as the constant current source 128. Even if the DC specification of the output common mode voltage VC is concentrated on the side of the VDD away from the vicinity of VDD/2, the DC specification of the output common mode voltage VC is satisfied, so that an improvement in yield may be achieved.

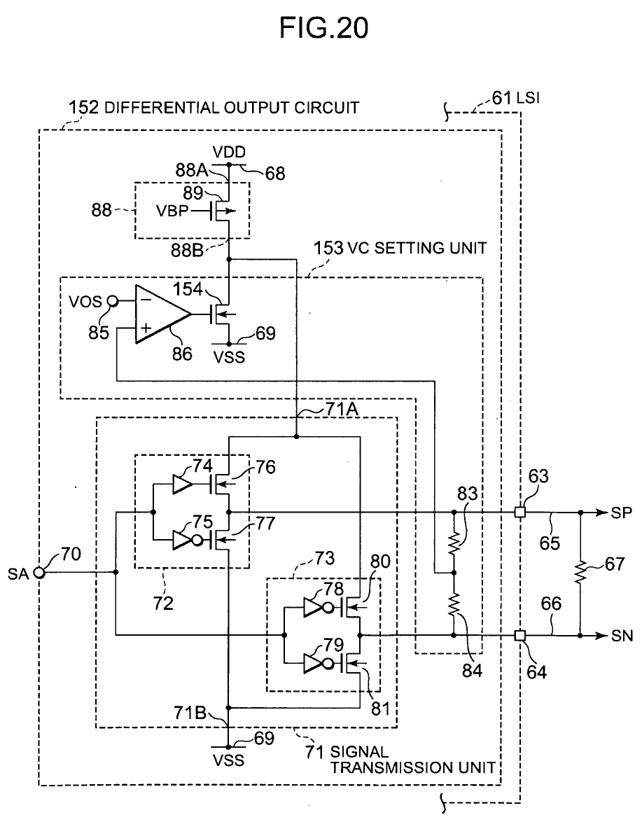

FIG. 20 illustrates aspects of a fifth embodiment. A differential output circuit 152 is a modification of the differential output circuit 62 shown in FIG. 7. A VC setting unit 153 that is different from the VC setting unit 82 in FIG. 7 is provided in aspects of the fifth embodiment. A current output terminal 88B of a constant current source 88 is coupled to a first power supply terminal 71A of a signal transmission unit 71. Other structural elements may be the same as those of the differential output circuit 62 in the first embodiment.

A VC setting unit 153 includes an NMOS transistor 154, as a variable resistor element, instead of the PMOS transistor 87 of the VC setting unit 82 shown in FIG. 7. An output terminal of an operational amplifier 86 is coupled to a gate of the NMOS transistor 154. A drain of the NMOS transistor 154 is coupled to the current output terminal 88B of the constant current source 88, and a source of the NMOS transistor 154 is coupled to a VSS power supply line 69. Other structural elements are the same as those of the VC setting unit 82.

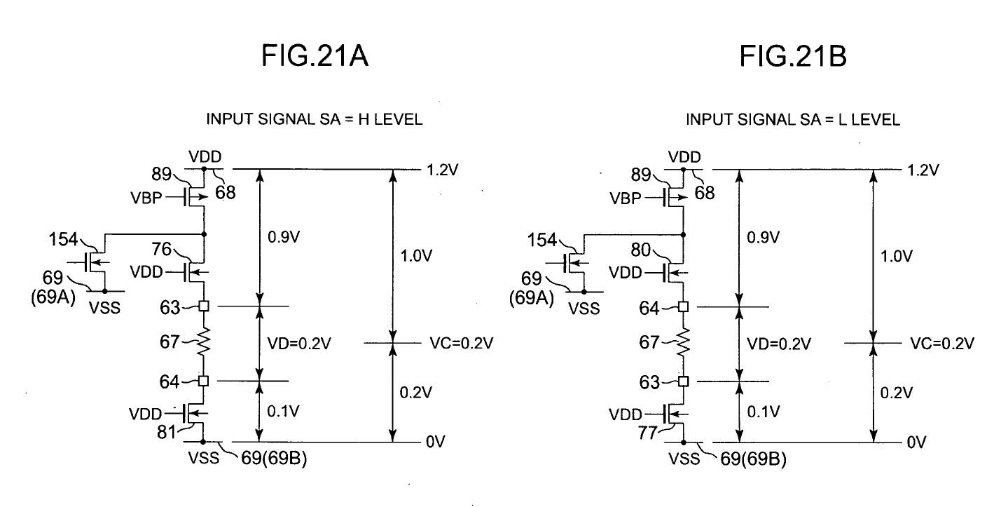

FIGS. 21A and 21B illustrate exemplary output voltages of external output terminals 63 and 64. FIG. 21A indicates where an input signal SA is a high level, and FIG. 21B indicates where the input signal SA is a low level.

For example, when a power supply voltage VDD is equal to 1.2V and a power supply voltage VSS is equal to 0V, a DC specification of the differential output circuit 152 may be defined as follows:

Output differential voltage VD=0.2 Vp-p

Output common mode voltage VC=0.2V

If the input signal SA is the high level, as shown in FIG. 21A, 0.9V is applied across a VDD power supply line 68 and the external output terminal 63 and 0.1V is applied across the external output terminal 64 and the VSS power supply line 69. If the input signal SA is the low level, as shown in FIG. 21B, 0.9V is applied across the VDD power supply line 68 and the external output terminal 64 and 0.1V is applied across an external output terminal 63 and the VSS power supply line 69. Regardless of whether the input signal SA is the high level or the low level, enough voltage is provided as a source-drain voltage VSD of a PMOS transistor 89 that serves as the constant current source 88.

For example, when the VDD is equal to 1.2V and the VSS is equal to 0V, the DC specification of the differential output circuit 152 may be defined as follows:

Output differential voltage VD=0.2 Vp-p

Output common mode voltage VC=VDD/2=0.6V

If the input signal SA is the high level, 0.5V is applied across the VDD power supply line 68 and the external output terminal 63 and across the external output terminal 64 and the VSS power supply line 69. If the input signal SA is the low level, 0.5V is applied across the VDD power supply line 68 and the external output terminal 64 and across the external output terminal 63 and the VSS power supply line 69. Enough voltage is provided as the source-drain voltage VSD of the PMOS transistor 89 that serves as the constant current source 88.

The differential output circuit 152 may be used, for example, as a differential interface circuit for transferring image data for a mobile phone. Reflection characteristics represented by S-parameters are included in the specification of the differential interface circuit used for transferring the image data. The differential output 152 may fully satisfy the required specification.

In the differential output circuit 152, if the input signal SA is the high level, as shown in FIG. 21A, paths from the external output terminal 63 to the VDD power supply line 68, which is regarded a fixed terminal, and to the VSS power supply line 69A, which is regarded a fixed terminal, include a series circuit. The series circuit includes an NMOS transistor 76, the PMOS transistor 89, and the NMOS transistor 154. Note that the PMOS transistor 89 and the NMOS transistor 154 may be regarded as being coupled in parallel. A path from the external output terminal 64 to a VSS power supply line 69B includes an NMOS transistor 81.

As shown in FIG. 21B, if the input signal SA is the low level, paths from the external output terminal 64 to the VDD power supply line 68, which is regarded a fixed terminal, and to the VSS power supply line 69A, which is regarded a fixed terminal, include a series circuit. The series circuit includes an NMOS transistor 80, the PMOS transistor 89, and the NMOS transistor 154. Note that the PMOS transistor 89 and the NMOS transistor 154 may be regarded as being coupled in parallel. A path from the external output circuit 63 to the VSS power supply line 69B includes an NMOS transistor 77.

If the input signal SA is the high level, DC resistance values between the external output terminal 63 and the VDD power supply line 68 and between the external output terminal 63 and the VSS power supply line 69A may be defined as 50Ω and a DC resistance value between the external output terminal 64 and the VSS power supply line 69B may be defined as 50Ω. Note that a parasitic reactance caused by an LSI package, or the like, may be negligible. Both an output impedance on a side of the differential output circuit 152 as viewed from the external output terminal 63 and an output impedance on a side of the differential output circuit 152 as viewed from the external output terminal 64 may be matched to a characteristic impedance, which may be approximately 50Ω, of transmission paths coupled to the external output terminals.

If the input signal SA is the low level, the DC resistance values between the external output terminal 64 and the VDD power supply line 68 and between the external output terminal 64 and the VSS power supply line 69A may be defined as 50Ω and the DC resistance value between the external output terminal 63 and the VSS power supply line 69B may be defined as 50Ω. Each of the output impedance on the side of the differential output circuit 152 as viewed from the external output terminal 63 and the output impedance on the side of the differential output circuit 152 as viewed from the external output terminal 64 may be matched to the characteristic impedance, which may be approximately 50Ω.

If the both the output impedance on the side of the differential output circuit 152 as viewed from the external output terminal 63 and the output impedance on the side of the differential output circuit 152 as viewed from the external output terminal 64 are matched to the characteristic impedance, which may be approximately 50Ω, reflection coefficients of the external output terminals 63 and 64 may be 0 or close to 0. Consequently, an improvement in values of S-parameters Sdd11, Scc11, and Scd11 is achieved. For example, a DC resistance value of the PMOS transistor 89 may be set to 120Ω, a DC resistance value of the NMOS transistor 154 may be set to 60Ω, DC resistance values of the NMOS transistors 76 and 80 may be set to 10Ω, and resistance values of the NMOS transistors 77 and 81 may be set to 50Ω, respectively. Both a DC resistance value on the side of the differential output circuit 152, as viewed from the external output terminal 63, and a DC resistance value on the side of the differential output circuit 152, as viewed from the external output terminal 64, may be set to 50Ω. Consequently, both the output impedance on the side of the differential output circuit 152, as viewed from the external output terminal 63, and the output impedance on the side of the differential output circuit 152, as viewed from the external output terminal 64, are matched to the characteristic impedance, which is approximately 50Ω.

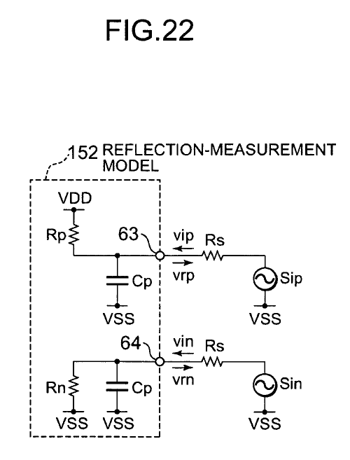

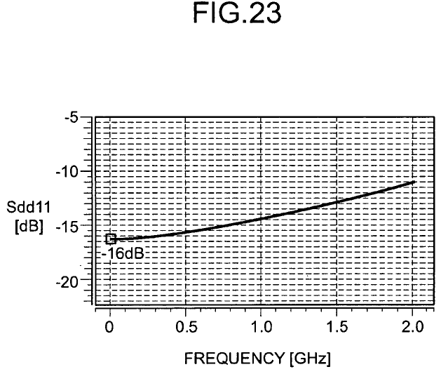

FIG. 22 illustrates a reflection-measurement model according to aspects of the fifth embodiment. Reference symbol Rp in the reflection-measurement model 152 indicates a DC resistance component between the external output terminal 63 and the VDD power supply line and between the external output terminal 63 and the VSS power supply line. Reference symbol Rn in the reflection-measurement model 152 indicates a DC resistance component between the external output terminal 64 and the VSS power supply line. Reference symbols Cp indicate parasitic capacitors, which may be approximately 1 to 2 pF. Reference symbols Rs indicate termination resistors. Reference symbols Sip and Sin indicate signal sources. The S-parameters Sdd11, Scc11, and Scd11 are represented by Formulae 1.

$$\begin{matrix}Sdd 11 = 20 {log}_{10} \vert Γ dd 11 \vert \\ = 20 {log}_{10} \vert Vrd / Vid \vert \\ Scc 11 = 20 {log}_{10} \vert Γ cc 11 \vert \\ = 20 {log}_{10} \vert Vcr / Vic \vert \\ Scd 11 = 20 {log}_{10} \vert Γ cd 11 \vert \\ = 20 {log}_{10} \vert Vrc / Vid \vert\end{matrix} \qquad [ Formulae 1 ]$$

Reference symbol Γdd11 indicates a reflection coefficient that indicates a relationship between a differential input and a differential output. Reference symbol Γcc11 indicates a reflection coefficient that indicates a relationship between an in-phase input and an in-phase output. Reference symbol Γcd11 indicates a reflection coefficient that indicates a relationship between a differential input and an in-phase output. Reference symbol Vid indicates a differential input. Reference symbol Vic indicates an in-phase input. Reference symbol Vrd indicates differential reflection. Reference symbol Vrc indicates in-phase reflection and is represented by Formulae 2.

$$\begin{matrix}Vid = \vert vip - vin \vert \\ Vic = ( vip + vin ) / 2 \\ Vrd = \vert vrp - vrn \vert \\ = \vert Γ p * vip - Γ n * vin \vert \\ Vrc = ( vrp + vrn ) / 2 \\ = ( Γ p * vip + Γ n * vin ) / 2\end{matrix} \qquad [ Formulae 2 ]$$

Reference symbol vip indicates an input voltage to the external output terminal 63. Reference symbol vin indicates an input voltage to the external output terminal 64. Reference symbol vrp indicates a reflection voltage from the external output terminal 63. Reference symbol vrn indicates a reflection voltage from the external output terminal 64.

If the following formulae are satisfied, that is, Rp=50Ω, Rn=50Ω, Rs=50Ω, and Cp=OpF, the reflection coefficient Γp of the external output terminal 63 and the reflection coefficient Γn of the external output terminal 64 are represented by Formulae 3.

$$Γ p = \frac{Rp - Rs}{Rp + Rs} = \frac{50 - 50}{50 + 50} = 0 \\ Γ n = \frac{Rn - Rs}{Rn + Rs} = \frac{50 - 50}{50 + 50} = 0 \qquad [ Formulae 3 ]$$

The S-parameters Sdd11, Scc11, and Scd11 are theoretically represented by Formulae 4.

Sdd11=−∞ [dB]

Scc11=−∞ [dB]

Scd11=−∞ [dB] [Formulae 4]

FIG. 23 illustrates a frequency characteristic of the S-parameter Sdd11. The frequency characteristic shown in FIG. 23 is obtained as a result of a circuit simulation performed on the reflection-measurement model shown in FIG. 22. A horizontal axis represents a signal frequency [in units of] [GHz], and a vertical axis represents the Sdd11 [in units of] [dB]. The formula, Sdd11=0 [dB], indicates full reflection, and the formula, Sdd11=−∞ [dB], indicates no reflection.

According to the result of the circuit simulation shown in FIG. 23, if the signal frequency is nearly equal to (≈) 0 [Hz], the S-parameter Sdd11 is nearly equal to (≈) −16 [dB]. For example, as a reflection specification of the differential interface circuit for transferring the image data used for the mobile phone, a specification may be required which satisfies the following formula, a maximum value of the [S-parameter] Sdd11=−14 [dB] when a frequency range is equal to or less than 1 GHz. Aspects of the fifth embodiment satisfy the above specification.

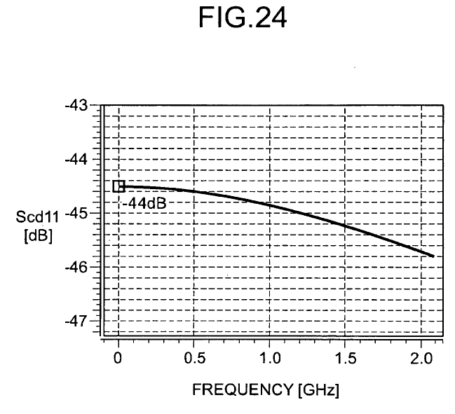

FIG. 24 illustrates a frequency characteristic of the S-parameter Scd11.

A frequency characteristic in FIG. 24 is obtained as a result of a circuit simulation performed on the reflection-measurement model shown in FIG. 22. A horizontal axis represents a signal frequency [GHz], and a vertical axis represents the Scd11 [dB]. The formula, Scd11=0[dB], indicates full reflection, and the formula, Scd11=−∞ [dB], indicates no reflection.

According to the result of the circuit simulation shown in FIG. 18, if the signal frequency is nearly equal to (≈) 0 [Hz], the S-parameter Scd11 is nearly equal to (≈) −44 [dB]. For example, as the reflection specification of the differential interface circuit for transferring the image data used for the mobile phone, a specification may be desired which satisfies a formula, a maximum value of the [S-parameter] Scd11=−26 [dB]. Aspects of the fifth embodiment satisfy the above specification.

According to aspects of the fifth embodiment, if the constant current source 88 is provided on an upstream side of the signal transmission unit 71 on a current path from the VDD power supply line 68 to the VSS power supply line 69, the NMOS transistor 154 that serves as the variable resistor element of the VC setting unit 153 is coupled between the current output terminal 88B of the constant current source 88 and the VSS power supply line 69. Even if a DC specification of the output common mode voltage VC is concentrated on a side of the VSS away from a vicinity of VDD/2, enough voltage is provided as the source-drain voltage VSD of the PMOS transistor 89 that serves as the constant current source 88. Consequently, if the DC specification of the output common mode voltage VC is concentrated on the side of the VSS away from the vicinity of VDD/2, the DC specification of the output common mode voltage VC is satisfied, so that an improvement in yield may be achieved.

The NMOS transistor 154 that serves as the variable resistor element of the VC setting unit 153 is coupled between the current output terminal 88B of the constant current source 88 and the VSS power supply line 69. The output impedance on the side of the differential output circuit 152 as viewed from the external output terminal 63 and the output impedance on the side of the differential output circuit 152 as viewed from the external output terminal 64 may be matched to the characteristic impedance by the adjustment of the DC resistance value of the PMOS transistor 89 and of the DC resistance values of the NMOS transistors 76, 77, 80, 81, and 154. Therefore, an improvement in the reflection characteristics is achieved.

The number of stages of the transistors provided between the VDD power supply line 68 and the signal transmission unit 71 is one. That is to say, only the PMOS transistor 89 of the constant current source 88 is provided. For this reason, the power supply voltage VDD becomes lower, so that power consumption may be reduced.

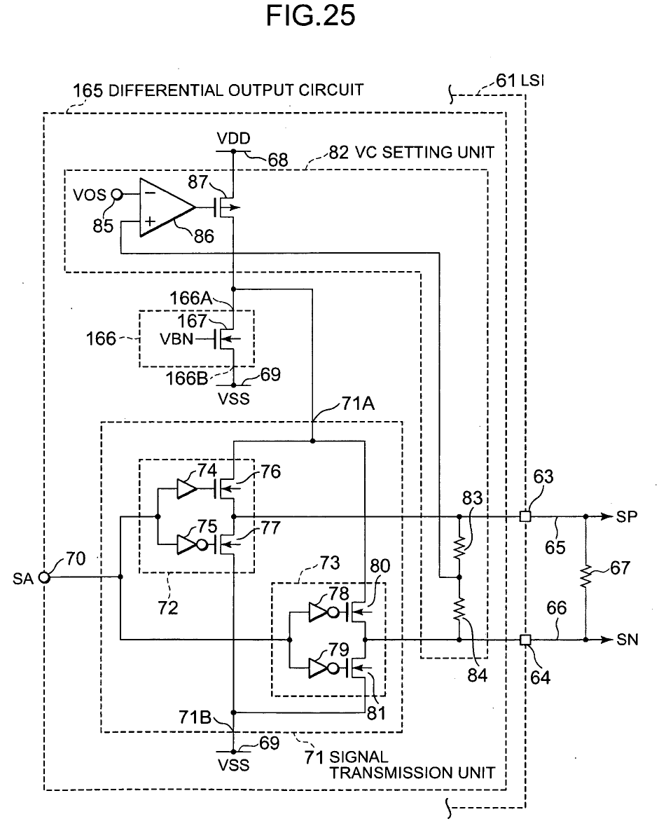

FIG. 25 illustrates aspects of a sixth embodiment. A differential output circuit 165 is a modification of the differential output circuit 95 shown in FIG. 11. The differential output circuit 165 includes a constant current source 166 that is different from the constant current source 88 for the VC setting unit 82 shown in FIG. 11. A drain of a PMOS transistor 87 of a VC setting unit 82 is coupled to a first power supply terminal 71A of a signal transmission unit 71.

Other structural elements may be the same as those of the differential output circuit 95 according to the second embodiment.

The constant current source 166 includes an NMOS transistor 167 instead of the PMOS transistor 89 in the constant current source 88 shown in FIG. 11.

A drain of the NMOS transistor 167 is coupled, via a current input terminal 166A of the constant current source 166, to the drain of the PMOS transistor 87 of the VC setting unit 82. A source of the NMOS transistor 167 is coupled, via a current output terminal 166B of the constant current source 166, to a VSS power supply line 69. A gate-bias voltage VBN is supplied to a gate of the NMOS transistor 167.

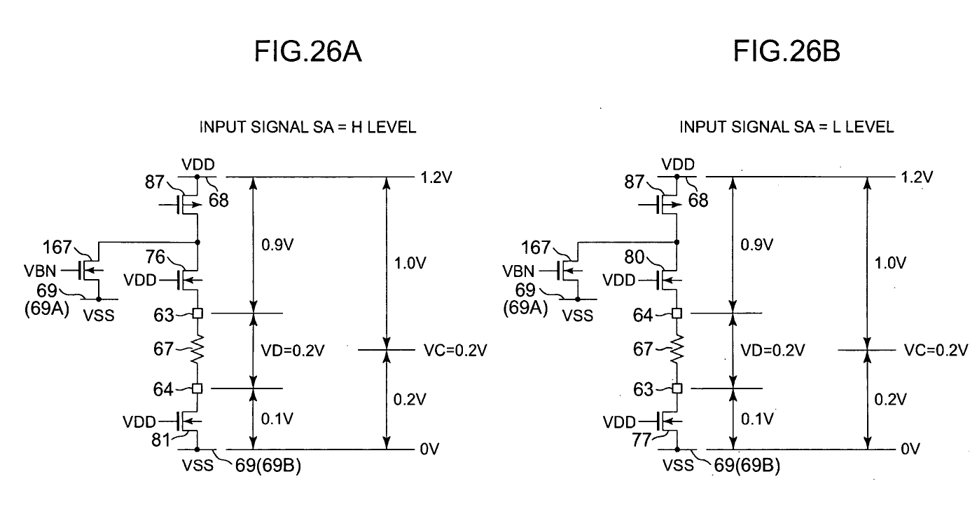

FIGS. 26A and 26B illustrate exemplary output voltages of external output terminals 63 and 64. FIG. 26A indicates where an input signal SA is a high level, and FIG. 26B indicates where the input signal SA is a low level.

For example, where a power supply voltage VDD is equal to 1.2V and a power supply voltage VSS is equal to 0V, a DC specification of the differential output circuit 165 may be defined as follows:

Output differential voltage VD=0.2 Vp-p

Output common mode voltage VC=0.2V

If the input signal SA is the high level, as shown in FIG. 26A, 0.9V is applied across a VDD power supply line 68 and the external output terminal 63 and 0.1V is applied across the external output terminal 64 and the VSS power supply line 69. If the input signal SA is the low level, as shown in FIG. 26B, 0.9V is applied across the VDD power supply line 68 and the external output terminal 64 and 0.1V is applied across the external output terminal 63 and the VSS power supply line 69.

Regardless of whether the input signal SA is the high level or the low level, 1.2V is applied across a source of the PMOS transistor 87 and the source of the NMOS transistor 167. Therefore, regardless of whether the input signal SA is the high level or the low level, enough voltage is provided as a drain-source voltage VDS of the NMOS transistor 167 that serves as the constant current source 166.

For example, when the VDD is equal to 1.2V and the VSS is equal to 0V, the DC specification of the differential output circuit 95 according to the second embodiment (shown in FIG. 11) may be defined as follows:

Output differential voltage VD=0.2 Vp-p

Output common mode voltage VC=VDD/2=0.6V

If the input signal SA is the high level, 0.5V is applied across the VDD power supply line 68 and the external output terminal 63 and across the external output terminal 64 and the VSS power supply line 69. If the input signal SA is the low level, 0.5V is applied across the VDD power supply line 68 and the external output terminal 64 and across the external output terminal 63 and the VSS power supply line 69.

Regardless of whether the input signal SA is the high level or the low level, 1.2V is applied across the source of the PMOS transistor 87 and the source of the NMOS transistor 167. Enough voltage is provided as the drain-source voltage VDS of the NMOS transistor 167 that serves as the constant current source 166.

If the input signal SA is the high level, as shown in FIG. 26A, paths from the external output terminal 63 to the VDD power supply line 68, which is regarded a fixed terminal, and to a VSS power supply line 69A, which is regarded a fixed terminal, include a series circuit, in the differential output circuit 165. The series circuit includes an NMOS transistor 76, the PMOS transistor 87, and the NMOS transistor 167. Note that the PMOS transistor 87 and the NMOS transistor 167 may be regarded as being coupled in parallel. A path from the external output terminal 64 to a VSS power supply line 69B includes an NMOS transistor 81.

If the input signal SA is the low level, as shown in FIG. 26B, paths from the external output terminal 64 to the VDD power supply line 68, which is regarded a fixed terminal, and to the VSS power supply line 69A, which is regarded a fixed terminal, include a series circuit. The series circuit includes an NMOS transistor 80, the PMOS transistor 87, and the NMOS transistor 167. Note that the PMOS transistor 87 and the NMOS transistor 167 may be regarded as being coupled in parallel. A path from the external output circuit 63 to the VSS power supply line 69B includes an NMOS transistor 77.

If the input signal SA is the high level, DC resistance values between the external output terminal 63 and the VDD power supply line 68 and between the external output terminal 63 and the VSS power supply line 69A may be set to 50Ω and a DC resistance value between the external output terminal 64 and the VSS power supply line 69B may be set to 50Ω. An output impedance on a side of the differential output circuit 165 as viewed from the external output terminal 63 and an output impedance on a side of the differential output circuit 165 as viewed from the external output terminal 64 are matched to a characteristic impedance (50Ω), respectively.

If the input signal SA is the low level, the DC resistance values between the external output terminal 64 and the VDD power supply line 68 and between the external output terminal 64 and the VSS power supply line 69A may be set to 50Ω and the DC resistance value between the external output terminal 63 and the VSS power supply line 69B may be set to 50Ω. The output impedance on the side of the differential output circuit 165 as viewed from the external output terminal 63 and the output impedance on the side of the differential output circuit 165 as viewed from the external output terminal 64 may be matched to a characteristic impedance, which is approximately 50Ω, respectively.

If the both the output impedance on the side of the differential output circuit 165 as viewed from the external output terminal 63 and the output impedance on the side of the differential output circuit 165 as viewed from the external output terminal 64 may be matched to the characteristic impedance, which is approximately 50Ω, reflection coefficients of the external output terminals 63 and 64 become 0 or close to 0. Consequently, an improvement in values of S-parameters Sdd11, Scc11, and Scd11 is achieved.

For example, the DC resistance value of the PMOS transistor 87 may be set to 120Ω, the DC resistance value of the NMOS transistor 167 may be set to 60Ω, DC resistance values of the NMOS transistors 76 and 80 may be set to 10Ω and DC resistance values of the NMOS transistors 77 and 81 may be set to 50Ω, respectively. Both the DC resistance value on the side of the differential output circuit 165, as viewed from the external output terminal 63, and the DC resistance value on the side of the differential output circuit 165, as viewed from the external output terminal 64, may be set to 50Ω. Both the output impedance on the side of the differential output circuit 165, as viewed from the external output terminal 63, and the output impedance on the side of the differential output circuit 165, as viewed from the external output terminal 64, may be matched to the characteristic impedance, which is approximately 50Ω.

According to aspects of the sixth embodiment, if the VC setting unit 82 is provided on an upstream side of the signal transmission unit 71 on a current path from the VDD power supply line 68 to the VSS power supply line 69, the constant current source 166 is coupled between the source of the PMOS transistor 87 that serves as the variable resistor element of the VC setting unit 82 and the VSS power supply line 69. Even if a DC specification of the output common mode voltage VC is concentrated on the side of the VSS away from the vicinity of VDD/2, enough voltage is provided as the drain-source voltage VDS of the NMOS transistor 167 that serves as the constant current source 166. Even if the DC specification of the output common mode voltage VC is concentrated on a side of the VSS away from a vicinity of VDD/2, the DC specification of the output common mode voltage VC is satisfied, so that an improvement in yield may be achieved.

The constant current source 166 is coupled between the drain of the PMOS transistor 87 of the VC setting unit 82 and the VSS power supply line 69. Therefore, both the output impedance on the side of the differential output circuit 165, as viewed from the external output terminal 63, and the output impedance on the side of the differential output circuit 165, as viewed from the external output terminal 64, may be matched to the characteristic impedance by the adjustment of the DC resistance value of the PMOS transistor 87 and of the DC resistance values of the NMOS transistors 76, 77, 80, 81, and 167. An improvement in reflection characteristics is achieved.

The number of stages of the transistors provided between the VDD power supply line 68 and the signal transmission unit 71 is one. That is to say, only the PMOS transistor 87 as a variable resistor element of the VC setting unit 82 is provided. For this reason, the power supply voltage VDD becomes lower, so that power consumption may be reduced.

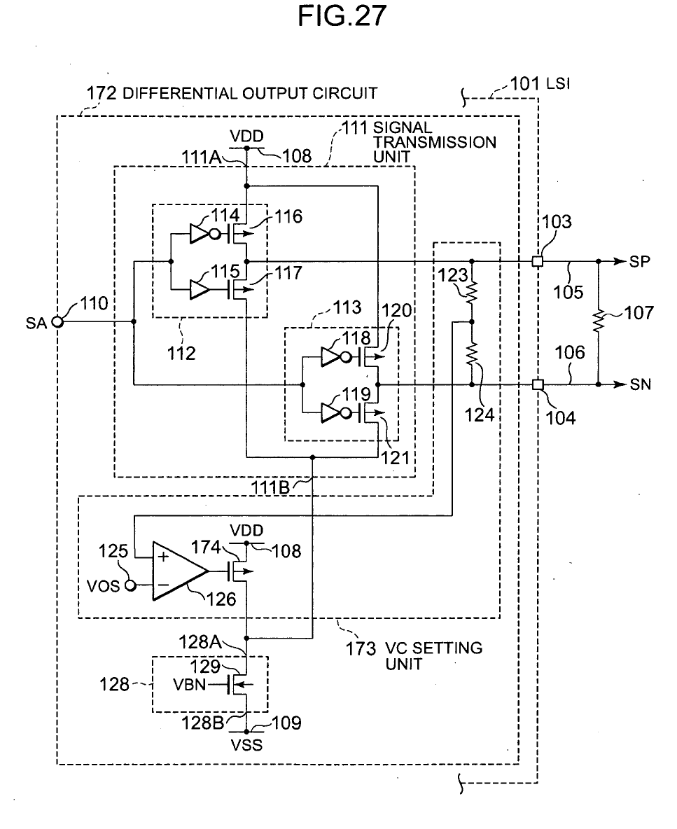

FIG. 27 illustrates aspects of a seventh embodiment. A differential output circuit 172 is a modification of the differential output circuit 102 shown in FIG. 14. The differential output circuit 172 includes a VC setting unit 173 whose circuit configuration is different from that of the VC setting unit 122. A second power supply terminal 111B of a signal transmission unit 111 is coupled to a current input terminal 128A of a constant current source 128. Other structural elements may be the same as those of the differential output circuit 102 according to the third embodiment.

The VC setting unit 173 includes a PMOS transistor 174, as a variable resistance element, instead of the NMOS transistor 127 of the VC setting unit 122 shown in FIG. 14. An output of an operational amplifier 126 is coupled to a gate of the PMOS transistor 174. A source of the PMOS transistor 174 is coupled to a VDD power supply line 108, and a drain of the PMOS transistor 174 is coupled to the current input terminal 128A of the constant current source 128. Other structural elements are the same as those of the VC setting unit 122 shown in FIG. 14.

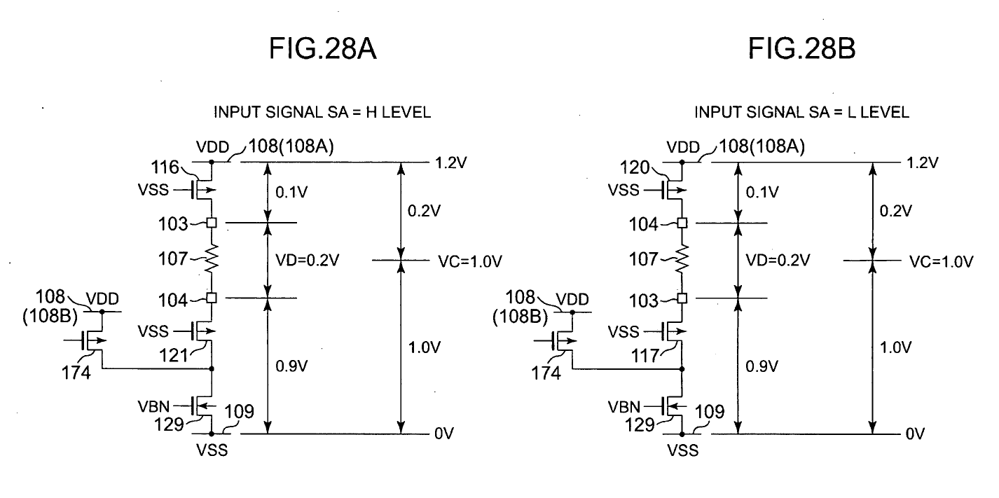

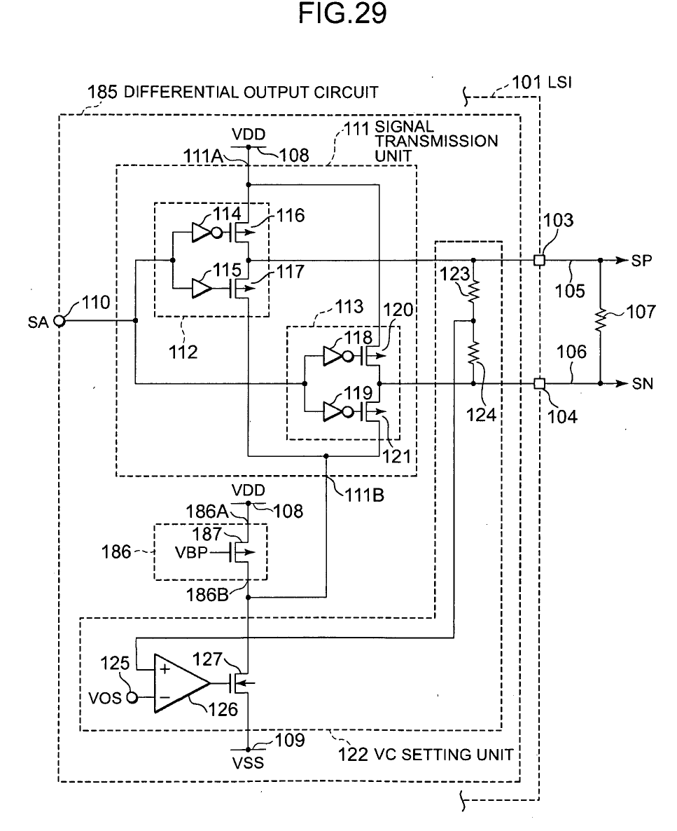

FIGS. 28A and 28B illustrate exemplary output voltages of external output terminals 103 and 104. FIG. 28A indicates where an input signal SA is an high level, and FIG. 28B indicates where the input signal SA is an low level.

For example, when a power supply voltage VDD is equal to 1.2V and a power supply voltage VSS is equal to 0V, a DC specification of the differential output circuit 172 according to aspects of the seventh embodiment may be defined as follows:

Output differential voltage VD=0.2 Vp-p

Output common mode voltage VC=1.0V

If the input signal SA is the high level, as shown in FIG. 28A, 0.1V is applied across the VDD power supply line 108 and the external output terminal 103 and 0.9V is applied across the external output terminal 104 and a VSS power supply line 109. If the input signal SA is the low level, as shown in FIG. 28B, 0.1V is applied across the VDD power supply line 108 and the external output terminal 104 and 0.9V is applied across the external output terminal 103 and the VSS power supply line 109. Regardless of whether the input signal SA is the high level or the low level, enough voltage is provided as a drain-source voltage VDS of an NMOS transistor 129 that serves as the constant current source 128.

For example, when the VDD is equal to 1.2V and the VSS is equal to 0V, the DC specification of the differential output circuit 172 may be defined as follows:

Output differential voltage VD=0.2 Vp-p

Output common mode voltage VC=0.6V

If the input signal SA is the high level, 0.5V is applied across the VDD power supply line 108 and the external output terminal 103 and across the external output terminal 104 and the VSS power supply line 109. If the input signal SA is the low level, 0.5V is applied across the VDD power supply line 108 and the external output terminal 104 and across the external output terminal 103 and the VSS power supply line 109. Enough voltage is provided as the drain-source voltage VDS of the NMOS transistor 129 that serves as the constant current source 128.

If the input signal SA is the high level, as shown in FIG. 28A, a path from the external output terminal 103 to a VDD power supply line 108A includes a PMOS transistor 116, in the seventh embodiment. Paths from the external output terminal 104 to a VDD power supply line 108B, which is regarded a fixed terminal, and to the VSS power supply line 109, which is regarded as fixed terminal, include a series circuit. The series circuit includes a PMOS transistor 121, the PMOS transistor 174, and the NMOS transistor 129. Note that the PMOS transistor 174 and the NMOS transistor 129 may be regarded as being coupled in parallel.

If the input signal SA is the low level, as shown in FIG. 28B, a path from the external output terminal 104 to the VDD power supply line 108A includes a PMOS transistor 120. Paths from the external output terminal 103 to the VDD power supply line 108B, which is regarded a fixed terminal, and to the VSS power supply line 109, which is regarded a fixed terminal, include a series circuit. The series circuit includes a PMOS transistor 117, the PMOS transistor 174, and the NMOS transistor 129. Note that the PMOS transistor 174 and the NMOS transistor 129 may be regarded as being coupled in parallel.

If the input signal SA is the high level, for example, a DC resistance value between the external output terminal 103 and the VDD power supply line 108A may be defined as 50Ω and DC resistance values between the external output terminal 104 and the VDD power supply line 108B and between the external output terminal 104 and the VSS power supply line 109 may be defined as 50Ω. As a result, both an output impedance on a side of the differential output circuit 172, as viewed from the external output terminal 10,3 and an output impedance on a side of the differential output circuit 172, as viewed from the external output terminal 104, may be matched to a characteristic impedance, which is approximately 50 Ω.

If the input signal SA is the low level, a DC resistance value between the external output terminal 104 and the VDD power supply line 108A may be defined as 50Ω and DC resistance values between the external output terminal 103 and the VDD power supply line 108B and between the external output terminal 103 and the VSS power supply line 109 may be defined as 50Ω. As a result, both the output impedance on the side of the differential output circuit 172, as viewed from the external output terminal 103, and the output impedance on the side of the differential output circuit 172, as viewed from the external output terminal 104, may be matched to the characteristic impedance, which is approximately 50 Ω.

If both the output impedance on the side of the differential output circuit 172, as viewed from the external output terminal 103, and the output impedance on the side of the differential output circuit 172, as viewed from the external output terminal 104, may be matched to the characteristic impedance, which is approximately 50Ω, reflection coefficients of the external output terminals 103 and 104 become 0 or close to 0. Consequently, an improvement in values of S-parameters Sdd11, Scc11, and Scd11 is achieved.

For example, a DC resistance value of the NMOS transistor 129 may be set to 120Ω, a DC resistance value of the PMOS transistor 174 may be set to 60Ω, DC resistance values of the PMOS transistors 117 and 121 may be set to 10Ω and DC resistance values of the PMOS transistors 116 and 120 may be set to 50Ω. Both the output impedance on the side of the differential output circuit 172, as viewed from the external output terminal 103, and the output impedance on the side of the differential output circuit 172, as viewed from the external output terminal 104, become 50Ω and may be matched to the characteristic impedance, which is approximately 50 Ω.

According to aspects of the seventh embodiment, if the constant current source 128 is provided on a down-stream side of the signal transmission unit 111 on a current path from the VDD power supply line 108 to the VSS power supply line 109, the PMOS transistor 174 that serves as the variable resistor element of the VC setting unit 173 is coupled between the VDD power supply line 108 and the current input terminal 128A of the constant current source 128. Even if a DC specification of the output common mode voltage VC is concentrated on a side of the VDD away from a vicinity of VDD/2, enough voltage is provided as the drain-source voltage VDS of the NMOS transistor 129 that serves as the constant current source 128. Therefore, even if the DC specification of the output common mode voltage VC is concentrated on the side of the VDD away from the vicinity of VDD/2, the DC specification of the output common mode voltage VC is satisfied, so that an improvement in yield may be achieved.

The PMOS transistor 174 that serves as the variable resistor element of the VC setting unit 173 is coupled between the VDD power supply line 108 and the current input terminal 128A of the constant current source 128. The both the output impedance on the side of the differential output circuit 172, as viewed from the external output terminal 103, and the output impedance on the side of the differential output circuit 172, as viewed from the external output terminal 104, may be matched to the characteristic impedance by the adjustment of the DC resistance values of the PMOS transistors 116, 117, 120, 121, and 174 and of the DC resistance value of the NMOS transistor 129. An improvement in reflection characteristics is achieved.

The number of stages of the transistors provided between the signal transmission unit 111 and the VSS power supply line 109 is one. That is to say, only the NMOS transistor 129 of the constant current source 128 is provided. For this reason, the power supply voltage VDD becomes lower, so that power consumption may be reduced.

FIG. 29 illustrates aspects of an eighth embodiment. A differential output circuit 185 is a modification of the differential output circuit 135 shown in FIG. 17. The differential output circuit 185 includes a constant current source 186 that is different from the constant current source 128 of the differential output circuit 135. A second power supply terminal 111B of a signal transmission unit 111 is coupled to a drain of an NMOS transistor 127 of a VC setting unit 122. Other structural elements may be the same as those of the differential output circuit 135 according to the fourth embodiment.

The constant current source 186 includes a PMOS transistor 187 instead of the NMOS transistor 129 of the constant current source 128 shown in FIG. 17. A source of the PMOS transistor 187 is coupled, via a current input terminal 186A of the constant current source 186, to a VDD power supply line 108. A drain of the PMOS transistor 187 is coupled, via a current output terminal 186B of the constant current source 186, to the drain of the NMOS transistor 127 of the VC setting unit 122. A gate-bias voltage VBP is supplied to a gate of the PMOS transistor 187.

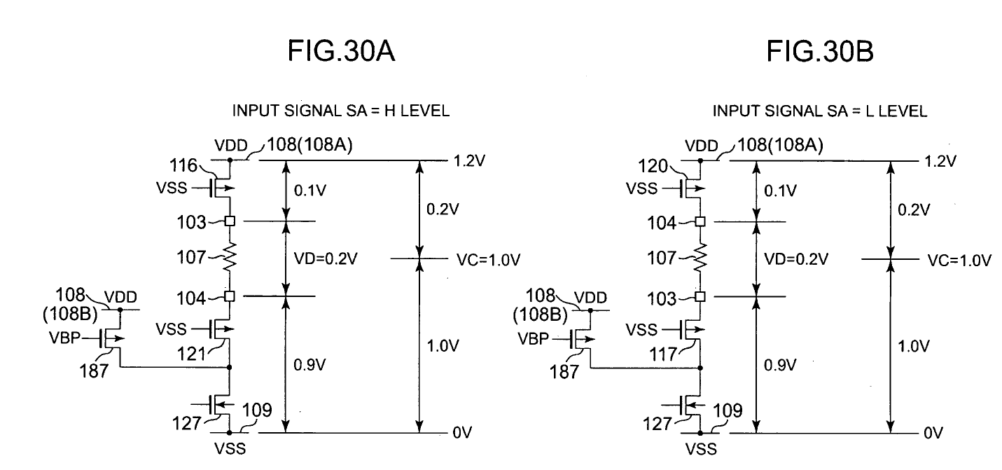

FIGS. 30A and 30B illustrate exemplary output voltages of external output terminals 103 and 104. FIG. 30A indicates where an input signal SA is a high level, and FIG. 30B indicates where the input signal SA is a low level.

For example, when a power supply voltage VDD is equal to 1.2V and a power supply voltage VSS is equal to 0V, a DC specification of the differential output circuit 185 may be defined as follows:

Output differential voltage VD=0.2 Vp-p

Output common mode voltage VC=1.0V

If the input signal SA is the high level, as shown in FIG. 30A, 0.1V is applied across a VDD power supply line 108 and the external output terminal 103 and 0.9V is applied across the external output terminal 104 and a VSS power supply line 109. If the input signal SA is the low level, as shown in FIG. 30B, 0.1V is applied across the VDD power supply line 108 and the external output terminal 104 and 0.9V is applied across the external output terminal 103 and the VSS power supply line 109.

Regardless of whether the input signal SA is the high level or the low level, 1.2V is applied across the source of the PMOS transistor 187 and a source of the NMOS transistor 127. Regardless of whether the input signal SA is the high level or the low level, enough voltage is provided as a source-drain voltage VSD of the PMOS transistor 187 that serves as the constant current source 186.

For example, when the VDD is equal to 1.2V and the VSS is equal to 0V, the DC specification of the differential output circuit 185 may be defined as follows:

Output differential voltage VD=0.2 Vp-p

Output common mode voltage VC=0.6V

If the input signal SA is the high level, 0.5V is applied across the VDD power supply line 108 and the external output terminal 103 and across the external output terminal 104 and the VSS power supply line 109. If the input signal SA is the low level, 0.5V is applied across the VDD power supply line 108 and the external output terminal 104 and across the external output terminal 103 and the VSS power supply line 109. Enough voltage is provided as a drain-source voltage VDS of the PMOS transistor 187 that serves as the constant current source 186.

If the input signal SA is the high level, as shown in FIG. 30A, a path from the external output terminal 103 to a VDD power supply line 108A includes a PMOS transistor 116, in the eighth embodiment. Paths from the external output terminal 104 to a VDD power supply line 108B, which is regarded a fixed terminal, and to the VSS power supply line 109, which is regarded a fixed terminal, include a series circuit. The series circuit includes a PMOS transistor 121, the PMOS transistor 187, and the NMOS transistor 127. Note that the PMOS transistor 187 and the NMOS transistor 127 may be regarded as being coupled in parallel.

If the input signal SA is the low level, as shown in FIG. 30B, a path from the external output terminal 104 to the VDD power supply line 108A includes a PMOS transistor 120. Paths from the external output terminal 103 to the VDD power supply line 108B, which is regarded a fixed terminal, and to the VSS power supply line 109, which is regarded a fixed terminal, include a series circuit. The series circuit includes a PMOS transistor 117, the PMOS transistor 187, and the NMOS transistor 127. Note that the PMOS transistor 187 and the NMOS transistor 127 may be regarded as being coupled in parallel.

If the input signal SA is the high level, a DC resistance value between the external output terminal 103 and the VDD power supply line 108A may be defined as 50Ω and DC resistance values between the external output terminal 104 and the VDD power supply line 108B and between the external output terminal 104 and the VSS power supply line 109 may be defined as 50Ω. Both an output impedance on a side of the differential output circuit 185, as viewed from the external output terminal 103, and an output impedance on a side of the differential output circuit 185, as viewed from the external output terminal 104, may be matched to a characteristic impedance, which is approximately 50Ω.

If the input signal SA is the low level, a DC resistance value between the external output terminal 104 and the VDD power supply line 108A may be defined as 50Ω and DC resistance values between the external output terminal 103 and the VDD power supply line 108B and between the external output terminal 103 and the VSS power supply line 109 may be defined as 50Ω. Both the output impedance on the side of the differential output circuit 185, as viewed from the external output terminal 103, and the output impedance on the side of the differential output circuit 185, as viewed from the external output terminal 104, may be matched to the characteristic impedance, which is approximately 50Ω.

If both the output impedance on the side of the differential output circuit 185, as viewed from the external output terminal 103, and the output impedance on the side of the differential output circuit 185, as viewed from the external output terminal 104, may be matched to the characteristic impedance, which is approximately 50Ω, reflection coefficients of the external output terminals 103 and 104 are set to 0 or close 0. An improvement in values of S-parameters Sdd11, Scc11, and Scd11 is achieved.

For example, a DC resistance value of the NMOS transistor 127 may be set to 120Ω, a DC resistance value of the PMOS transistor 187 may be set to 60Ω, DC resistance values of the PMOS transistors 117 and 121 may be set to 10Ω and DC resistance values of the PMOS transistors 116 and 120 may be set to 50Ω. Both the output impedance on the side of the differential output circuit 185, as viewed from the external output terminal 103, and the output impedance on the side of the differential output circuit 185, as viewed from the external output terminal 104, become 50Ω and may be matched to the characteristic impedance, which is approximately 50Ω.

According to aspects of the eighth embodiment, if the VC setting unit 122 is provided on a down-stream side of the signal transmission unit 111 on a current path from the VDD power supply line 108 to the VSS power supply line 109, the constant current source 186 is coupled between the VDD power supply line 108 and the drain of the NMOS transistor 127 of the VC setting unit 122. Even if a DC specification of the output common mode voltage VC is concentrated on a side of the VDD away from a vicinity of VDD/2, enough voltage is provided as the source-drain voltage VSD of the PMOS transistor 187 that serves as the constant current source 186. Consequently, even if the DC specification of the output common mode voltage VC is concentrated on the side of the VDD away from the vicinity of VDD/2, the DC specification of the output common mode voltage VC is satisfied, so that an improvement in yield may be achieved.

The constant current source 186 is coupled between the VDD power supply line 108 and the drain of the NMOS transistor 127 of the VC setting unit 122. Therefore, both the output impedance on the side of the differential output circuit 185, as viewed from the external output terminal 103, and the output impedance on the side of the differential output circuit 185, as viewed from the external output terminal 104, may be matched to the characteristic impedance by the adjustment of the DC resistance values of the PMOS transistors 116, 117, 120, 121, and 187 and of the DC resistance value of the NMOS transistor 127. An improvement in reflection characteristics is achieved.

The number of stages of the transistors provided between the signal transmission unit 111 and the VSS power supply line 109 is one. That is to say, only the NMOS transistor 127 that serves as the variable resistor element of the VC setting unit 122 is provided. For this reason, the power supply voltage VDD becomes lower, so that power consumption may be reduced.

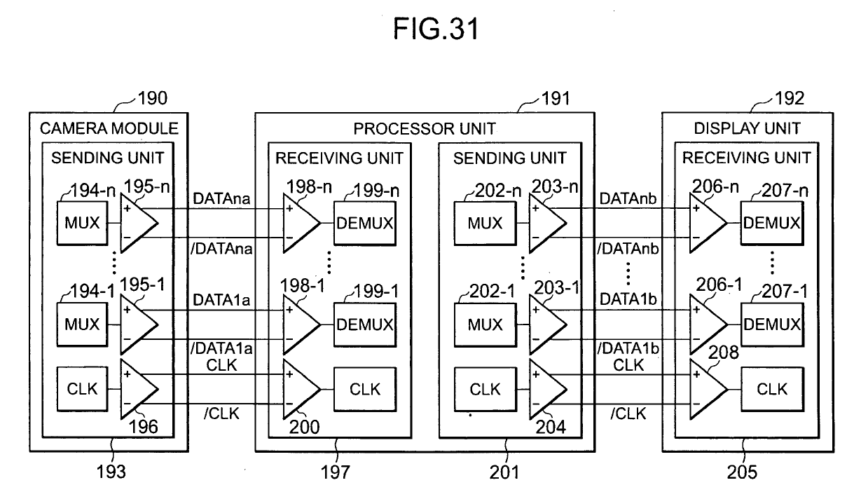

FIG. 31 illustrates aspects of a ninth embodiment. FIG. 31 illustrates a system which includes a LSI having a differential output circuit according to one of the first embodiment through the eighth embodiment. For example, as shown in FIG. 31, the system includes a synchronous-type interface, provided in a mobile phone, for transferring image data and clocks. Reference numeral 190 indicates a camera module. Reference numeral 191 indicates a processor unit. Reference numeral 192 indicates a display unit. The camera module 190, the processor unit 191, and the display unit 192 may be made up of different LSI chips. These LSI chips send/receive the image data and the clocks with a high-speed data transfer technique.

The camera module 190 performs an A/D conversion on analogue image signals obtained with a CCD sensor or the like, thereafter converts digital data into serial data to transfer to the processor unit 191. Reference numeral 193 indicates a sending unit. Reference numerals 194-1 and 194-n indicate a multiplexer. Reference numeral 195-1 indicates a differential output circuit that implements a complement of image data output from the multiplexer 194-1 to output. Reference numeral 195-n indicates a differential output circuit that implements a complement of image data output from the multiplexer 194-n to output. Illustration of multiplexers 194-2 to 194-(n−1) and differential output circuits 195-2 to 195-(n−1) is omitted. Reference numeral 196 indicates a differential output circuit that implements a complement of a clock CLK to output. For example, the differential output circuits according to the first to the eighth embodiments may be the differential output circuits 195-1 to 195-n and 196 shown in FIG. 31.

The processor unit 191 receives image data DATA1a, /DATA1a to DATAna, /DATAna, and clocks CLK, /CLK that are sent by the sending unit 193 of the camera module 190 and processes image signals. Reference numeral 197 indicates a receiving unit. Reference numeral 198-1 indicates a differential input circuit, to which the image data DATA1a and /DATA1a are input. Reference numeral 198-n indicates a differential input circuit, to which the image data DATAna and /DATAna are input. Reference numeral 199-1 indicates a demultiplexer that demultiplexes the image data received by the differential input circuit 198-1. Reference numeral 199-n indicates a demultiplexer that demultiplexes the image data received by the differential input circuit 198-n. Illustration of the differential input circuits 198-2 to 198-(n−1) and the demultiplexers 199-2 to 199-(n−1) is omitted. Reference numeral 200 indicates a differential input circuit, to which the clocks CLK and /CLK are input.

Reference numeral 201 indicates a sending unit. Reference numerals 202-1 and 202-n indicate multiplexers. Reference numeral 203-1 indicates a differential output circuit that implements a complement of image data output by the multiplexer 202-1 to output. Reference numeral 203-n indicates a differential output circuit that implements a complement of image data output by the multiplexer 202-n to output. Illustration of the multiplexers 202-2 to 202-(n−1) and the differential output circuits 203-2 to 203-(n−1) is omitted. Reference numeral 204 indicates a differential output circuit that implements a complement of the clock CLK to output. For example, the differential output circuits according to the first to eighth embodiments may be the differential output circuits 203-1 to 203-n and 204 shown in FIG. 31.

The display unit 192 receives image data DATA1b, /DATA1b to DATAnb, /DATAnb, and clocks CLK, /CLK sent by the sending unit 201 of the processor unit 191 and displays the data on a liquid crystal display panel or the like through a driver. Reference numeral 205 indicates a receiving unit. Reference numeral 206-1 indicates a differential input circuit, to which the image data DATA1b and /DATA1b are input. Reference numeral 206-n indicates a differential input circuit, to which the image data DATAnb and /DATAnb are input. Reference numeral 207-1 indicates a demultiplexer that demultiplexes the image data received by the differential input circuit 206-1. Reference numeral 207-n indicates a demultiplexer that demultiplexes the image data received by the differential input circuit 206-n. Illustration of differential input circuits 206-2 to 206-(n−1) and the demultiplexer 207-2 to 207-(n−1) is omitted. Reference numeral 208 indicates a differential input circuit, to which the clocks CLK and /CLK are input.

Transfer of the image data DATA1a, /DATA1a to DATAna, and /DATAna from the sending unit 193 of the camera module 190 to the receiving unit 197 of the processor unit 191 and transfer of the image data DATA1b, /DATA1b to DATAnb, and /DATAnb from the sending unit 201 of the processor unit 191 to the receiving unit 205 of the display unit 192 are synchronized with a highly multiplied clock CLK by a phase-locked loop (PLL). In the ninth embodiment, quality of signals used for high-speed data transfer among LSI chips is maintained.

Aspects of example embodiments of the present invention have now been described in accordance with the above advantages. It will be appreciated that these examples are merely illustrative of the invention. Many variations and modifications will be apparent to those skilled in the art.

1. A differential output circuit comprising:
a first power supply line that supplies a first voltage;
a constant current source that includes a current input terminal coupled to the first power supply line and a current output terminal;
an output common mode voltage setting unit that includes a variable resistor element, one end of the variable resistor element being coupled to the current output terminal; and
a signal transmission unit that includes a first power supply terminal and a second power supply terminal, the first power supply terminal being coupled to the other end of the variable resistor element, and the second power supply terminal being coupled to a second power supply line which supplies a second voltage lower than the first voltage.

2. A differential output circuit comprising:
a first power supply line that supplies a first voltage;
an output common mode voltage setting unit that includes a variable resistor element, one end of the variable resistor element being coupled to the first power supply line;
a constant current source that includes a current input terminal coupled to the other end of the variable resistor element and a current output terminal; and
a signal transmission unit that includes a first power supply terminal and a second power supply terminal, the first power supply terminal being coupled to the current output terminal, and the second power supply terminal being coupled to a second power supply line supplying a second voltage lower than the first voltage.

3. The differential output circuit according to claim 1, wherein the signal transmission unit comprises:
a first output buffer, coupled between a first signal terminal and a second signal terminal, that outputs a first output signal in phase with an input signal supplied to the first signal terminal; and
a second output buffer, coupled between the first signal terminal and a third signal terminal, that outputs a second output signal in anti-phase with the input signal.

4. The differential output circuit according to claim 2, wherein the signal transmission unit comprises:
a first output buffer, coupled between a first signal terminal and a second signal terminal, that outputs a first output signal in phase with an input signal supplied to the first signal terminal; and
a second output buffer, coupled between the first signal terminal and a third signal terminal, that outputs a second output signal in anti-phase with the input signal.

5. The differential output circuit according to claim 3, wherein the first output buffer comprises:
a first buffer that includes an input terminal coupled to the first signal terminal and an output terminal;
a first N-channel field effect transistor that includes a gate terminal coupled to the output terminal of the first buffer, a drain terminal coupled to the first power supply terminal, and a source terminal coupled to the second signal terminal;
a first inverter that includes an input terminal coupled to the first signal terminal and an output terminal; and
a second N-channel field effect transistor that includes a gate terminal coupled to the output terminal of the first inverter, a drain terminal coupled to the second signal terminal, and a source terminal coupled to the second power supply terminal; and
wherein the second output buffer comprises:
a second inverter that includes an input terminal coupled to the first signal terminal and an output terminal;
a third N-channel field effect transistor that includes a gate coupled to the output terminal of the second inverter, a drain coupled to the first power supply terminal, and a source coupled to the third signal terminal,
a second buffer that includes an input terminal coupled to the first signal terminal and an output terminal; and
a fourth N-channel field effect transistor that includes a gate coupled to the output terminal of the second buffer, a drain coupled to the third signal terminal, and a source coupled to the second power supply terminal.

6. The differential output circuit according to claim 4, wherein the first output buffer comprises:
a first buffer that includes an input terminal coupled to the first signal terminal and an output terminal;
a first N-channel field effect transistor that includes a gate terminal coupled to the output terminal of the first buffer, a drain terminal coupled to the first power supply terminal, and a source terminal coupled to the second signal terminal;
a first inverter that includes an input terminal coupled to the first signal terminal and an output terminal; and
a second N-channel field effect transistor that includes a gate terminal coupled to the output terminal of the first inverter, a drain terminal coupled to the second signal terminal, and a source terminal coupled to the second power supply terminal; and
wherein the second output buffer comprises:
a second inverter that includes an input terminal coupled to the first signal terminal and an output terminal;
a third N-channel field effect transistor that includes a gate terminal coupled to the output terminal of the second inverter, a drain terminal coupled to the first power supply terminal, and a source terminal coupled to the third signal terminal;
a second buffer that includes an input terminal coupled to the first signal terminal and an output terminal; and
a fourth N-channel field effect transistor that includes a gate terminal coupled to the output terminal of the second buffer, a drain terminal coupled to the third signal terminal, and a source terminal coupled to the second power supply terminal.

7. A differential output circuit comprising:
a first power supply line that supplies a first voltage;
a signal transmission unit that includes a first power supply terminal coupled to the first power supply line and a second power supply terminal;
an output common mode voltage setting unit that includes a variable resistor element, one end of the variable resistor element being coupled to the second power supply terminal of the signal transmission unit; and
a constant current source that includes a current input terminal and a current output terminal, the current input terminal being coupled to the other end of the variable resistor element, and the current output terminal being coupled to a second power supply line supplying a second voltage lower than the first voltage.

8. A differential output circuit comprising:
a first power supply line that supplies a first voltage;
a signal transmission unit that includes a first power supply terminal coupled to the first power supply line and a second power supply terminal;
a constant current source that includes a current input terminal coupled to the second power supply terminal of the signal transmission unit and a current output terminal; and
an output common mode voltage setting unit that includes a variable resistor element, one end of the variable resistor element being coupled to the current output terminal of the constant current source, and the other end of the variable resistor element being coupled to a second power supply line supplying a second voltage lower than the first voltage.

9. The differential output circuit according to claim 7, wherein the signal transmission unit comprises:
a first output buffer, coupled between a first signal terminal and a second signal terminal, that outputs a first output signal in phase with an input signal supplied to the first signal terminal; and
a second output buffer, coupled between the first signal terminal and a third signal terminal, that outputs a second output signal in anti-phase with the input signal.

10. The differential output circuit according to claim 8, wherein the signal transmission unit comprises:
a first output buffer, coupled between a first signal terminal and a second signal terminal, that outputs a first output signal in phase with an input signal supplied to the first signal terminal; and
a second output buffer, coupled between the first signal terminal and a third signal terminal, that outputs a second output signal in anti-phase with the input signal.

11. The differential output circuit according to claim 9, wherein the first output buffer comprises:
a first inverter that includes an input terminal coupled to the first signal terminal and an output terminal;
a first P-channel field effect transistor that includes a gate terminal coupled to the output terminal of the first inverter, a source terminal coupled to the first power supply terminal, and a drain terminal coupled to the second signal terminal;
a first buffer that an input terminal coupled to the first signal terminal and an output terminal; and
a second P-channel field effect transistor that includes a gate terminal coupled to the output terminal of the first buffer, a source terminal coupled to the second signal terminal, and a drain terminal coupled to the second power supply terminal; and
wherein the second output buffer comprises:
a second buffer that includes an input terminal coupled to the first signal terminal and an output terminal;
a third P-channel field effect transistor that includes a gate terminal coupled to the output terminal of the second buffer, a source terminal coupled to the first power supply terminal, and a drain terminal coupled to the third signal terminal;
a second inverter that includes an input terminal coupled to the first signal terminal and an output terminal; and
a fourth P-channel field effect transistor that includes a gate terminal coupled to the output terminal of the second inverter, a source terminal coupled to the third signal terminal, and a drain terminal coupled to the second power supply terminal.

12. The differential output circuit according to claim 10, wherein the first output buffer comprises:
a first inverter that includes an input terminal coupled to the first signal terminal and an output terminal;
a first P-channel field effect transistor that includes a gate terminal coupled to the output terminal of the first inverter, a source terminal coupled to the first power supply terminal, and a drain terminal coupled to the second signal terminal;
a first buffer that includes an input terminal coupled to the first signal terminal and an output terminal; and
a second P-channel field effect transistor that includes a gate terminal coupled to the output terminal of the first buffer, a source terminal coupled to the second signal terminal, a drain terminal coupled to the second power supply terminal; and
wherein the second output buffer comprises:
a second buffer that includes an input terminal coupled to the first signal terminal and an output terminal;
a third P-channel field effect transistor that includes a gate terminal coupled to the output terminal of the second buffer, a source terminal coupled to the first power supply terminal, and a drain terminal coupled to the third signal terminal;
a second inverter that includes an input terminal coupled to the first signal terminal and an output terminal; and
a fourth P-channel field effect transistor that includes a gate terminal coupled to the output terminal of the second inverter, a source terminal coupled to the third signal terminal, and a drain terminal coupled to the second power supply terminal.

13. A differential output circuit comprising:
a first power supply line that supplies a first voltage;
a constant current source that includes a current input terminal coupled to the first power supply line and a current output terminal;
an output common mode voltage setting unit that includes a variable resistor element, one end of the variable resistor element being coupled to the current output terminal of the constant current source, and the other end of the variable resistor element being coupled to a second power supply line supplying a second voltage lower than the first voltage of the first power supply line; and
a signal transmission unit that includes a first power supply terminal and a second power supply terminal, the first power supply terminal being coupled to the current output terminal of the constant current source, and the second power supply terminal being coupled to the second power supply line.

14. A differential output circuit comprising:
a first power supply line that supplies a first voltage;
an output common mode voltage setting unit that includes a variable resistor element, one end of the variable resistor element being coupled to the first power supply line;
a constant current source that includes a current input terminal and a current output terminal, the current input terminal being coupled to the other end of the variable resistor element, and the current output terminal being coupled to a second power supply line supplying a second voltage lower than the first voltage of a first power supply line; and
a signal transmission unit that includes a first power supply terminal and a second power supply terminal, the first power supply terminal being coupled to the other end of the variable resistor element, and the second power supply terminal being coupled to the second power supply line.

15. A differential output circuit comprising:
a first power supply line that supplies a first voltage;
a signal transmission unit that includes a first power supply terminal coupled to the first power supply line;
a constant current source that includes a current input terminal and a current output terminal, the current input terminal being coupled to a second power supply terminal of the signal transmission unit, and the current output terminal being coupled to a second power supply line supplying a second voltage lower than the first voltage of the first power supply line; and
an output common mode voltage setting unit that includes a variable resistor element, one end of the variable resistor element being coupled to the first power supply line, and the other end of the variable resistor element being coupled to the current input terminal of the constant current source.

16. A differential output circuit comprising:
a first power supply line that supplies a first voltage;
a signal transmission unit that includes a first power supply terminal coupled to the first power supply line;
an output common mode voltage setting unit that includes a variable resistor element, one end of the variable resistor element being coupled to a second power supply terminal of the signal transmission unit, and the other end of the variable resistor element being coupled to a second power supply line supplying a second voltage lower than the first voltage of the first power supply line; and
a constant current source that includes a current input terminal and a current output terminal, the current input terminal being coupled to the first power supply line, and the current output terminal coupled to the one end of the variable resistor element.
